(19) United States
(12) Patent Application Publication
(10) Pub. No.: US 2026/0368331 A1
(43) Pub. Date: Nov. 19, 2026

(54) Threat Identification Using Natural Language Models

(71) Applicant: ServiceNow, Inc., Santa Clara, CA (US)

(72) Inventors: Matthew Thomas McDonald, Callahan, FL (US); Jeremy Wade Long, Herndon, VA (US)

(21) Appl. No.: 19/210,842

(22) Filed: May 16, 2025

(51) Int. Cl. G06F 21/57; G06F 21/54

(52) U.S. Cl. CPC G06F 21/577; G06F 21/54; G06F 2221/033

(57) ABSTRACT

An embodiment may include a method. The method may include receiving an indication of a change made to source code of an application. The method may also include, based on the indication of the change to the source code, identifying a representation within a threat model related to the change to the source code, the representation indicative of a vulnerability to the source code. The method may also include obtaining, based on the representation within the threat model, modified source code that mitigates the vulnerability to the source code. The method may also include providing the modified source code as an update to the application.

### BACKGROUND

Threat models, in the context of software development, are often used to identify possible threats and vulnerabilities. These threat models can be represented as a variation of a directed graph that contains information relating to relationships between hardware and software components involved in the functioning of an application. Thus, threat modeling is useful for identifying security risks in the application.

These security risks grow with changes that are made to an application. For instance, a new feature or function added to the application may open up possible vectors for a potential attacker (e.g., a user or malware) to exploit. Accordingly, the application, the computing systems it runs on, and/or its users may be subject to data corruption and/or loss, as well as disruptions and downtime as part of such an attack. As a consequence, the computing resources (e.g., processor capacity, memory capacity, network capacity, and energy usage) of compromised systems can be wasted or misused during and after such a security breach.

### SUMMARY

The embodiments herein provide techniques and mechanisms to determine the impact of potential source code changes and/or configuration data changes on the security of an application. To do so, a system can monitor such changes and responsively update a threat model associated with the application. The system may employ generative artificial intelligence (GenAI) to analyze the threat model and/or source code/configuration data changes for potential security risks and suggest further changes in order to address any discovered issues.

This presents a technical improvement, as timely updates to the threat model may help identify security risks in the application before they are put into production. Further, the suggested changes may also help address the security risks and improve the overall functioning of the application. By addressing security risks during software development, the embodiments herein aid in reducing instances of data exfiltration, corruption, and loss, system disruptions and downtime, and the waste and misuse of computing resources associated with unaddressed security risks.

Accordingly, a first example embodiment may involve a method. The method may include receiving an indication of a change made to source code of an application. The method may also include, based on the indication of the change to the source code, identifying a representation within a threat model related to the change to the source code, the representation indicative of a vulnerability to the source code. The method may also include obtaining, based on the representation within the threat model, modified source code that mitigates the vulnerability to the source code. The method may also include providing the modified source code as an update to the application.

A second example embodiment may involve a method. The method may include receiving an indication of a change made to configuration data of an application. The method may also include, based on the indication of the change to the configuration data, identifying a representation within a threat model related to the change to the configuration data, the representation indicative of a vulnerability related to the application. The method may also include obtaining, based on the representation within the threat model, modified configuration data that mitigates the vulnerability related to the application. The method may also include providing the modified configuration data as an update to the application.

A third example embodiment may involve a non-transitory computer-readable medium, having stored thereon program instructions that, upon execution by a computing system, cause the computing system to perform operations in accordance with any of the previous example embodiments.

In a fourth example embodiment, a computing system may include at least one processor, as well as memory and program instructions. The program instructions may be stored in the memory, and upon execution by the at least one processor, cause the computing system to perform operations in accordance with any of the previous example embodiments.

In a fifth example embodiment, a system may include various means for carrying out each of the operations of any of the previous example embodiments.

These, as well as other embodiments, aspects, advantages, and alternatives, will become apparent to those of ordinary skill in the art by reading the following detailed description, with reference where appropriate to the accompanying drawings. Further, this summary and other descriptions and figures provided herein are intended to illustrate embodiments by way of example only and, as such, that numerous variations are possible. For instance, structural elements and process steps can be rearranged, combined, distributed, eliminated, or otherwise changed, while remaining within the scope of the embodiments as claimed.

### BRIEF DESCRIPTION OF THE DRAWINGS

FIG. 1 illustrates a schematic drawing of a computing device, in accordance with example embodiments.

FIG. 2 illustrates a schematic drawing of a server device cluster, in accordance with example embodiments.

FIG. 3 depicts a remote network management architecture, in accordance with example embodiments.

FIG. 4 depicts a communication environment involving a remote network management architecture, in accordance with example embodiments.

FIG. 5 depicts another communication environment involving a remote network management architecture, in accordance with example embodiments.

FIG. 6A depicts types of configuration data, how the configuration data is stored, and where the configuration data can be stored, in accordance with example embodiments.

FIG. 6B depicts a set of configuration data for a software service, in accordance with example embodiments.

FIG. 6C depicts centralized storage of configuration data, in accordance with example embodiments.

FIG. 7 depicts a threat model, in accordance with example embodiments.

FIG. 8A depicts a change analysis system, in accordance with example embodiments.

FIG. 8B depicts a change analysis system, in accordance with example embodiments.

FIG. 9A depicts a message flow diagram, in accordance with example embodiments.

FIG. 9B depicts a message flow diagram, in accordance with example embodiments.

FIG. 10 depicts a flow chart, in accordance with example embodiments.

FIG. 11 depicts a flow chart, in accordance with example embodiments.

### DETAILED DESCRIPTION

Example methods, devices, and systems are described herein. It should be understood that the words “example” and “exemplary” are used herein to mean “serving as an example, instance, or illustration.” Any embodiment or feature described herein as being an “example” or “exemplary” is not necessarily to be construed as preferred or advantageous over other embodiments or features unless stated as such. Thus, other embodiments can be utilized and other changes can be made without departing from the scope of the subject matter presented herein.

Accordingly, the example embodiments described herein are not meant to be limiting. It will be readily understood that the aspects of the present disclosure, as generally described herein, and illustrated in the figures, can be arranged, substituted, combined, separated, and designed in a wide variety of different configurations. For example, the separation of software features into “client” and “server” components may occur in a number of ways.

Further, unless context suggests otherwise, the features illustrated in each of the figures may be used in combination with one another. Thus, the figures should be generally viewed as component aspects of one or more overall embodiments, with the understanding that not all illustrated features are necessary for each embodiment.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order.

Unless clearly indicated otherwise herein, the term “or” is to be interpreted as the inclusive disjunction. For example, the phrase “A, B, or C” is true if any one or more of the arguments A, B, C are true, and is only false if all of A, B, and C are false.

### I. Example Technical Improvements

These embodiments provide a technical improvement to a technical problem. One technical problem addressed is security risks that may arise when changes are made to application source code and/or configuration data. In practice, this is problematic because a new feature or function added to the application, or new item of configuration data, may open up possible vectors for a potential attacker (e.g., a user or malware) to exploit. Accordingly, the application, the computing systems it runs on, and/or its users may be subject to data corruption and/or loss, as well as disruptions and downtime as part of such an attack. As a consequence, the computing resources (e.g., processor capacity, memory capacity, network capacity, and energy usage) of compromised systems can be wasted or misused during and after such a security breach.

The embodiments herein address these issues by providing techniques and mechanisms to determine the impact of potential source code changes and/or configuration data changes on the security of an application. To do so, a system can monitor such changes and responsively update a threat model associated with the application. The system may employ generative artificial intelligence (GenAI) to analyze the threat model and/or source code/configuration data changes for potential security risks and suggest further changes in order to address any discovered issues. In this manner, the identification and rectification of possible security risks or vulnerabilities can be accomplished in a more accurate and robust fashion.

This results in several advantages, as timely updates to the threat model may help identify security risks in the application before they are put into production. Further, the suggested changes may also help address the security risks and improve the overall functioning of the application. By addressing security risks during software development, the embodiments herein aid in reducing instances of data exfiltration, corruption, and loss, system disruptions and downtime, and the waste and misuse of computing resources associated with unaddressed security risks.

Other technical improvements may also flow from these embodiments, and other technical problems may be addressed. Thus, this statement of technical improvements is not limiting and instead constitutes examples of advantages that can be realized from the embodiments.

### II. Introduction

A large enterprise is a complex entity with many interrelated operations. Some of these are found across the enterprise, such as human resources (HR), supply chain, information technology (IT), and finance. However, each enterprise also has its own unique operations that provide essential capabilities and/or create competitive advantages.

To support widely-implemented operations, enterprises typically use off-the-shelf software applications, such as customer relationship management (CRM), IT service management (ITSM), IT operations management (ITOM), and human capital management (HCM) packages. However, they may also need custom software applications to meet their own unique requirements. A large enterprise often has dozens or hundreds of these custom software applications. Nonetheless, the advantages provided by the embodiments herein are not limited to large enterprises and may be applicable to an enterprise, or any other type of organization, of any size.

Many such software applications are developed by individual departments within the enterprise. These range from simple spreadsheets to custom-built software tools and databases. But the proliferation of siloed custom software applications has numerous disadvantages. It negatively impacts an enterprise's ability to run and grow its operations, innovate, and meet regulatory requirements. The enterprise may find it difficult to integrate, streamline, and enhance its operations due to lack of a single system that unifies its subsystems and data.

To efficiently create custom applications, enterprises would benefit from a remotely-hosted application platform that eliminates unnecessary development complexity. The goal of such a platform would be to reduce time-consuming, repetitive application development tasks so that software engineers and individuals in other roles can focus on developing unique, high-value features.

In order to achieve this goal, the concept of Application Platform as a Service (aPaaS) has been introduced to intelligently automate workflows throughout the enterprise. An aPaaS system is hosted remotely from the enterprise, but may access data, applications, and services within the enterprise by way of secure connections. Such an aPaaS system may have a number of advantageous capabilities and characteristics. These advantages and characteristics may be able to improve the enterprise's operations and workflows for IT, HR, CRM, customer service, application development, and security. Nonetheless, the embodiments herein are not limited to enterprise applications or environments, and can be more broadly applied.

The aPaaS system may support development and execution of model-view-controller (MVC) applications. MVC applications divide their functionality into three interconnected parts (model, view, and controller) in order to isolate representations of information from the manner in which the information is presented to the user, thereby allowing for efficient code reuse and parallel development. These applications may be web-based, and offer create, read, update, and delete (CRUD) capabilities. This allows new applications to be built on a common application infrastructure. In some cases, applications structured differently than MVC, such as those using unidirectional data flow, may be employed.

The aPaaS system may support standardized application components, such as a standardized set of widgets and/or web components for graphical user interface (GUI) development. In this way, applications built using the aPaaS system have a common look and feel. Other software components and modules may be standardized as well. In some cases, this look and feel can be branded or skinned with an enterprise's custom logos and/or color schemes.

The aPaaS system may support the ability to configure the behavior of applications using metadata. This allows application behaviors to be rapidly adapted to meet specific needs. Such an approach reduces development time and increases flexibility. Further, the aPaaS system may support GUI tools that facilitate metadata creation and management, thus reducing errors in the metadata.

The aPaaS system may support clearly-defined interfaces between applications, so that software developers can avoid unwanted inter-application dependencies. Thus, the aPaaS system may implement a service layer in which persistent state information and other data are stored.

The aPaaS system may support a rich set of integration features so that the applications thereon can interact with legacy applications and third-party applications. For instance, the aPaaS system may support a custom employee-onboarding system that integrates with legacy HR, IT, and accounting systems.

The aPaaS system may support enterprise-grade security. Furthermore, since the aPaaS system may be remotely hosted, it should also utilize security procedures when it interacts with systems in the enterprise or third-party networks and services hosted outside of the enterprise. For example, the aPaaS system may be configured to share data amongst the enterprise and other parties to detect and identify common security threats.

Other features, functionality, and advantages of an aPaaS system may exist. This description is for purpose of example and is not intended to be limiting.

As an example of the aPaaS development process, a software developer may be tasked to create a new application using the aPaaS system. First, the developer may define the data model, which specifies the types of data that the application uses and the relationships therebetween. Then, via a GUI of the aPaaS system, the developer enters (e.g., uploads) the data model. The aPaaS system automatically creates all of the corresponding database tables, fields, and relationships, which can then be accessed via an object-oriented services layer.

In addition, the aPaaS system can also build a fully-functional application with client-side interfaces and server-side CRUD logic. This generated application may serve as the basis of further development for the user. Advantageously, the developer does not have to spend a large amount of time on basic application functionality. Further, since the application may be web-based, it can be accessed from any Internet-enabled client device. Alternatively or additionally, a local copy of the application may be able to be accessed, for instance, when Internet service is not available.

The aPaaS system may also support a rich set of pre-defined functionality that can be added to applications. These features include support for searching, email, templating, workflow design, reporting, analytics, social media, scripting, mobile-friendly output, and customized GUIs.

Such an aPaaS system may represent a GUI in various ways. For example, a server device of the aPaaS system may generate a representation of a GUI using a combination of HyperText Markup Language (HTML) and JAVASCRIPT®. The JAVASCRIPT® may include client-side executable code, server-side executable code, or both. The server device may transmit or otherwise provide this representation to a client device for the client device to display on a screen according to its locally-defined look and feel. Alternatively, a representation of a GUI may take other forms, such as an intermediate form (e.g., JAVA® byte-code) that a client device can use to directly generate graphical output therefrom. Other possibilities exist, including but not limited to metadata-based encodings of web components, and various uses of JAVASCRIPT® Object Notation (JSON) and/or eXtensible Markup Language (XML) to represent various aspects of a GUI.

Further, user interaction with GUI elements, such as buttons, menus, tabs, sliders, checkboxes, toggles, etc. may be referred to as “selection”, “activation”, or “actuation” thereof. These terms may be used regardless of whether the GUI elements are interacted with by way of keyboard, pointing device, touchscreen, or another mechanism.

An aPaaS architecture is particularly powerful when integrated with an enterprise's network and used to manage such a network. The following embodiments describe architectural and functional aspects of example aPaaS systems, as well as the features and advantages thereof.

### III. Example Computing Devices and Cloud-Based Computing Environments

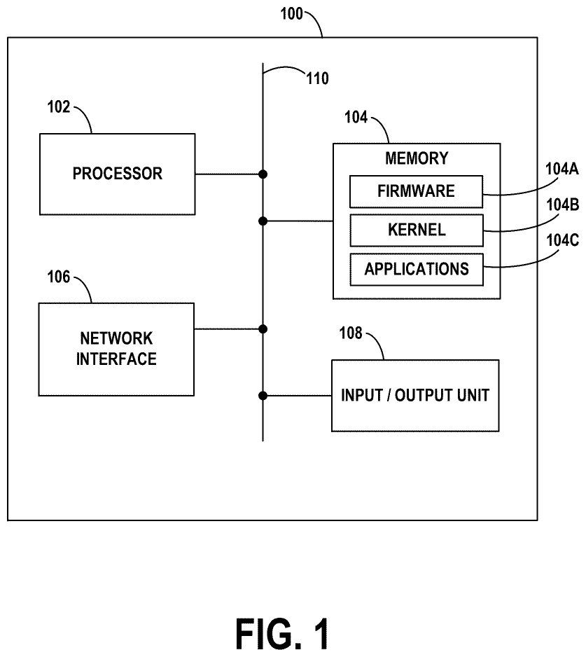

FIG. 1 is a simplified block diagram exemplifying a computing device 100, illustrating some of the components that could be included in a computing device arranged to operate in accordance with the embodiments herein. Computing device 100 could be a client device (e.g., a device actively operated by a user), a server device (e.g., a device that provides computational services to client devices), or some other type of computational platform. Some server devices may operate as client devices from time to time in order to perform particular operations, and some client devices may incorporate server features.

In this example, computing device 100 includes processor 102, memory 104, network interface 106, and input/output unit 108, all of which may be coupled by system bus 110 or a similar mechanism. In some embodiments, computing device 100 may include other components and/or peripheral devices (e.g., detachable storage, printers, and so on).

Processor 102 may be one or more of any type of computer processing element, such as a central processing unit (CPU), a graphical processing unit (GPU), a digital signal processor (DSP), a network processor, an encryption processor, and/or a form of integrated circuit or controller that performs processor operations. In some cases, processor 102 may be one or more single-core processors. In other cases, processor 102 may be one or more multi-core processors with multiple independent processing units. Processor 102 may also include register memory for temporarily storing instructions being executed and related data, as well as cache memory for temporarily storing recently used instructions and data.

GPUs, in particular, have grown in importance. They include specialized circuitry designed to perform rapid mathematical calculations for rendering graphics, processing large datasets, and supporting machine learning. A GPU typically consists of hundreds or thousands of small cores that operate simultaneously, facilitating the decomposition of tasks into smaller, more manageable pieces that are processed in parallel. This parallelism allows GPUs to be significantly faster than traditional CPUs for certain types of calculations.

Memory 104 may be any form of computer-usable memory, including but not limited to random access memory (RAM), read-only memory (ROM), and non-volatile memory (e.g., flash memory, hard disk drives, solid state drives, compact discs (CDs), digital video discs (DVDs), and/or tape storage). Thus, memory 104 represents both main memory units, as well as long-term storage. Herein, any non-volatile memory may be referred to as persistent storage.

Memory 104 may store program instructions and/or data on which program instructions may operate. By way of example, memory 104 may store these program instructions on a non-transitory, computer-readable medium, such that the instructions are executable by processor 102 to carry out any of the methods, processes, or operations disclosed in this specification or the accompanying drawings.

As shown in FIG. 1, memory 104 may include firmware 104A, kernel 104B, and/or applications 104C. Firmware 104A may be program code used to boot or otherwise initiate some or all of computing device 100. Kernel 104B may be an operating system, including modules for memory management, scheduling and management of processes, input/output, and communication. Kernel 104B may also include device drivers that allow the operating system to communicate with the hardware modules (e.g., memory units, networking interfaces, ports, and buses) of computing device 100. Applications 104C may be one or more user-space software programs, such as web browsers or email clients, as well as any software libraries used by these programs. Memory 104 may also store data used by these and other programs and applications.

Network interface 106 may take the form of one or more wireline interfaces, such as Ethernet (e.g., Fast Ethernet, Gigabit Ethernet, 10 Gigabit Ethernet, Ethernet over fiber, and so on). Network interface 106 may also support communication over one or more non-Ethernet media, such as coaxial cables or power lines, or over wide-area media, such as Synchronous Optical Networking (SONET), Synchronous Digital Hierarchy (SDH), Data Over Cable Service Interface Specification (DOCSIS), or other technologies. Network interface 106 may additionally take the form of one or more wireless interfaces, such as IEEE 802.11 (Wifi), BLUETOOTH®, global positioning system (GPS), or a wide-area wireless interface. However, other forms of physical layer interfaces and other types of standard or proprietary communication protocols may be used over network interface 106. Furthermore, network interface 106 may comprise multiple physical interfaces. For instance, some embodiments of computing device 100 may include Ethernet, BLUETOOTH®, and Wifi interfaces.

Input/output unit 108 may facilitate user and peripheral device interaction with computing device 100. Input/output unit 108 may include one or more types of input devices, such as a keyboard, a mouse, a touch screen, and so on. Similarly, input/output unit 108 may include one or more types of output devices, such as a screen, monitor, printer, and/or one or more light emitting diodes (LEDs). Additionally or alternatively, computing device 100 may communicate with other devices using a universal serial bus (USB) or high-definition multimedia interface (HDMI) port interface, for example.

In some embodiments, one or more computing devices like computing device 100 may be deployed. The exact physical location, connectivity, and configuration of these computing devices may be unknown and/or unimportant to client devices. Accordingly, the computing devices may be referred to as “cloud-based” devices that may be housed at various remote data center locations.

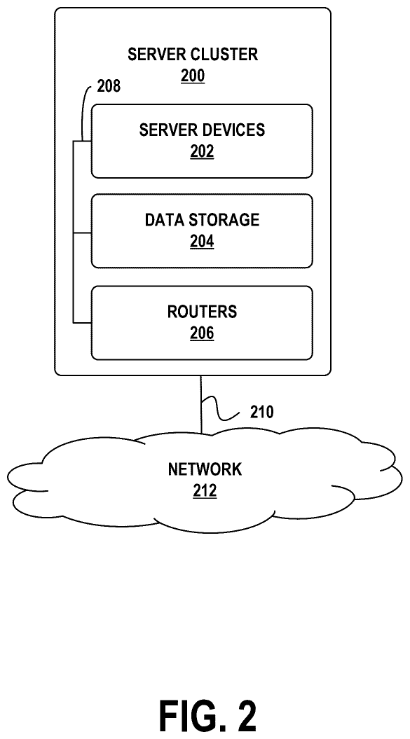

FIG. 2 depicts a cloud-based server cluster 200 in accordance with example embodiments. In FIG. 2, operations of a computing device (e.g., computing device 100) may be distributed between server devices 202, data storage 204, and routers 206, all of which may be connected by local cluster network 208. The number of server devices 202, data storages 204, and routers 206 in server cluster 200 may depend on the computing task(s) and/or applications assigned to server cluster 200.

For example, server devices 202 can be configured to perform various computing tasks of computing device 100. Thus, computing tasks can be distributed among one or more of server devices 202. To the extent that these computing tasks can be performed in parallel, such a distribution of tasks may reduce the total time to complete these tasks and return a result. For purposes of simplicity, both server cluster 200 and individual server devices 202 may be referred to as a “server device.” This nomenclature should be understood to imply that one or more distinct server devices, data storage devices, and cluster routers may be involved in server device operations.

Data storage 204 may be data storage arrays that include drive array controllers configured to manage read and write access to groups of hard disk drives and/or solid state drives. The drive array controllers, alone or in conjunction with server devices 202, may also be configured to manage backup or redundant copies of the data stored in data storage 204 to protect against drive failures or other types of failures that prevent one or more of server devices 202 from accessing units of data storage 204. Other types of memory aside from drives may be used.

Routers 206 may include networking equipment configured to provide internal and external communications for server cluster 200. For example, routers 206 may include one or more packet-switching and/or routing devices (including switches and/or gateways) configured to provide (i) network communications between server devices 202 and data storage 204 via local cluster network 208, and/or (ii) network communications between server cluster 200 and other devices via communication link 210 to network 212.

Additionally, the configuration of routers 206 can be based at least in part on the data communication requirements of server devices 202 and data storage 204, the latency and throughput of the local cluster network 208, the latency, throughput, and cost of communication link 210, and/or other factors that may contribute to the cost, speed, fault-tolerance, resiliency, efficiency, and/or other design goals of the system architecture.

As a possible example, data storage 204 may include any form of database, such as a structured query language (SQL) database or a No-SQL database (e.g., MongoDB). Various types of data structures may store the information in such a database, including but not limited to files, tables, arrays, lists, trees, and tuples. Furthermore, any databases in data storage 204 may be monolithic or distributed across multiple physical devices.

Server devices 202 may be configured to transmit data to and receive data from data storage 204. This transmission and retrieval may take the form of SQL queries or other types of database queries, and the output of such queries, respectively. Additional text, images, video, and/or audio may be included as well. Furthermore, server devices 202 may organize the received data into web page or web application representations. Such a representation may take the form of a markup language, such as HTML, XML, JSON, or some other standardized or proprietary format. Moreover, server devices 202 may have the capability of executing various types of computerized scripting languages, such as but not limited to Perl, Python, PHP Hypertext Preprocessor (PHP), Active Server Pages (ASP), JAVASCRIPT®, and so on. Computer program code written in these languages may facilitate the providing of web pages to client devices, as well as client device interaction with the web pages. Alternatively or additionally, JAVA® may be used to facilitate generation of web pages and/or to provide web application functionality.

### IV. Example Remote Network Management Architecture

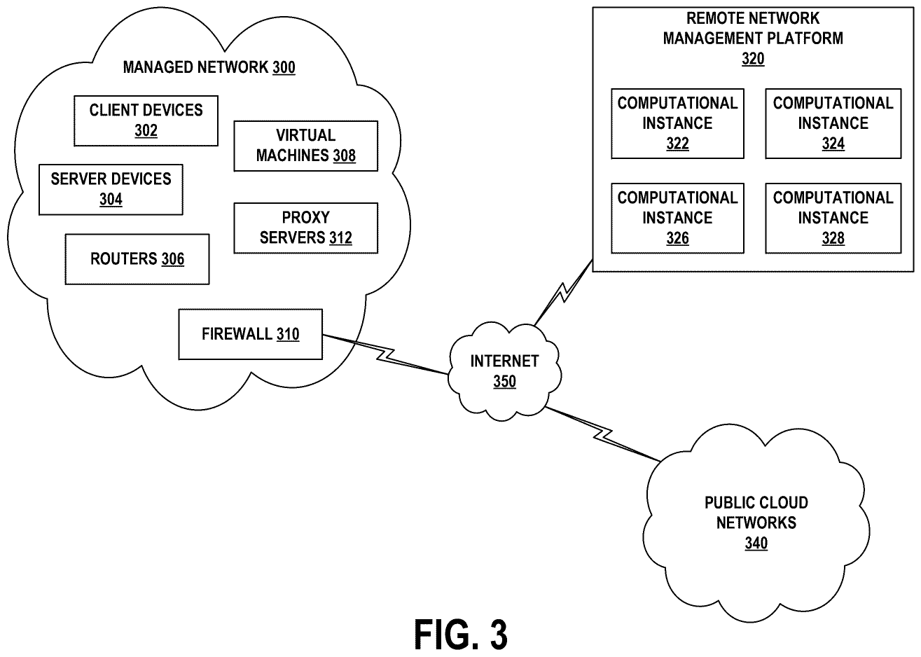

FIG. 3 depicts a remote network management architecture, in accordance with example embodiments. This architecture includes three main components—managed network 300, remote network management platform 320, and public cloud networks 340—all connected by way of Internet 350.

### A. Managed Networks

Managed network 300 may be, for example, an enterprise network used by an entity for computing and communications tasks, as well as storage of data. Thus, managed network 300 may include client devices 302, server devices 304, routers 306, virtual machines 308, firewall 310, and/or proxy servers 312. Client devices 302 may be embodied by computing device 100, server devices 304 may be embodied by computing device 100 or server cluster 200, and routers 306 may be any type of router, switch, or gateway.

Virtual machines 308 may be embodied by one or more of computing device 100 or server cluster 200. In general, a virtual machine is an emulation of a computing system, and mimics the functionality (e.g., processor, memory, and communication resources) of a physical computer. One physical computing system, such as server cluster 200, may support up to thousands of individual virtual machines. In some embodiments, virtual machines 308 may be managed by a centralized server device or application that facilitates allocation of physical computing resources to individual virtual machines, as well as performance and error reporting. Enterprises often employ virtual machines in order to allocate computing resources in an efficient, as needed fashion. Providers of virtualized computing systems include VMWARE® and MICROSOFT®.

Firewall 310 may be one or more specialized routers or server devices that protect managed network 300 from unauthorized attempts to access the devices, applications, and services therein, while allowing authorized communication that is initiated from managed network 300. Firewall 310 may also provide intrusion detection, web filtering, virus scanning, application-layer gateways, and other applications or services. In some embodiments not shown in FIG. 3, managed network 300 may include one or more virtual private network (VPN) gateways with which it communicates with remote network management platform 320 (see below).

Managed network 300 may also include one or more proxy servers 312. An embodiment of proxy servers 312 may be a server application that facilitates communication and movement of data between managed network 300, remote network management platform 320, and public cloud networks 340. In particular, proxy servers 312 may be able to establish and maintain secure communication sessions with one or more computational instances of remote network management platform 320. By way of such a session, remote network management platform 320 may be able to discover and manage aspects of the architecture and configuration of managed network 300 and its components.

Possibly with the assistance of proxy servers 312, remote network management platform 320 may also be able to discover and manage aspects of public cloud networks 340 that are used by managed network 300. While not shown in FIG. 3, one or more proxy servers 312 may be placed in any of public cloud networks 340 in order to facilitate this discovery and management.

Firewalls, such as firewall 310, typically deny all communication sessions that are incoming by way of Internet 350, unless such a session was ultimately initiated from behind the firewall (i.e., from a device on managed network 300) or the firewall has been explicitly configured to support the session. By placing proxy servers 312 behind firewall 310 (e.g., within managed network 300 and protected by firewall 310), proxy servers 312 may be able to initiate these communication sessions through firewall 310. Thus, firewall 310 might not have to be specifically configured to support incoming sessions from remote network management platform 320, thereby avoiding potential security risks to managed network 300.

In some cases, managed network 300 may consist of a few devices and a small number of networks. In other deployments, managed network 300 may span multiple physical locations and include hundreds of networks and hundreds of thousands of devices. Thus, the architecture depicted in FIG. 3 is capable of scaling up or down by orders of magnitude.

Furthermore, depending on the size, architecture, and connectivity of managed network 300, a varying number of proxy servers 312 may be deployed therein. For example, each one of proxy servers 312 may be responsible for communicating with remote network management platform 320 regarding a portion of managed network 300. Alternatively or additionally, sets of two or more proxy servers may be assigned to such a portion of managed network 300 for purposes of load balancing, redundancy, and/or high availability.

### B. Remote Network Management Platforms

Remote network management platform 320 is a hosted environment that provides aPaaS services to users, particularly to the operator of managed network 300. These services may take the form of web-based portals, for example, using the aforementioned web-based technologies. Thus, a user can securely access remote network management platform 320 from, for example, client devices 302, or potentially from a client device outside of managed network 300. By way of the web-based portals, users may design, test, and deploy applications, generate reports, view analytics, and perform other tasks. Remote network management platform 320 may also be referred to as a multi-application platform.

As shown in FIG. 3, remote network management platform 320 includes four computational instances 322, 324, 326, and 328. Each of these computational instances may represent one or more server nodes operating dedicated copies of the aPaaS software and/or one or more database nodes. The arrangement of server and database nodes on physical server devices and/or virtual machines can be flexible and may vary based on enterprise needs. In combination, these nodes may provide a set of web portals, services, and applications (e.g., a wholly-functioning aPaaS system) available to a particular enterprise. In some cases, a single enterprise may use multiple computational instances.

For example, managed network 300 may be an enterprise customer of remote network management platform 320, and may use computational instances 322, 324, and 326. The reason for providing multiple computational instances to one customer is that the customer may wish to independently develop, test, and deploy its applications and services. Thus, computational instance 322 may be dedicated to application development related to managed network 300, computational instance 324 may be dedicated to testing these applications, and computational instance 326 may be dedicated to the live operation of tested applications and services. A computational instance may also be referred to as a hosted instance, a remote instance, a customer instance, or by some other designation. Any application deployed onto a computational instance may be a scoped application, in that its access to databases within the computational instance can be restricted to certain elements therein (e.g., one or more particular database tables or particular rows within one or more database tables).

For purposes of clarity, the disclosure herein refers to the arrangement of application nodes, database nodes, aPaaS software executing thereon, and underlying hardware as a “computational instance.” Note that users may colloquially refer to the graphical user interfaces provided thereby as “instances.” But unless it is defined otherwise herein, a “computational instance” is a computing system disposed within remote network management platform 320.

The multi-instance architecture of remote network management platform 320 is in contrast to conventional multi-tenant architectures, over which multi-instance architectures exhibit several advantages. In multi-tenant architectures, data from different customers (e.g., enterprises) are comingled in a single database. While these customers'data are separate from one another, the separation is enforced by the software that operates the single database. As a consequence, a security breach in this system may affect all customers'data, creating additional risk, especially for entities subject to governmental, healthcare, and/or financial regulation. Furthermore, any database operations that affect one customer will likely affect all customers sharing that database. Thus, if there is an outage due to hardware or software errors, this outage affects all such customers. Likewise, if the database is to be upgraded to meet the needs of one customer, it will be unavailable to all customers during the upgrade process. Often, such maintenance windows will be long, due to the size of the shared database.

In contrast, the multi-instance architecture provides each customer with its own database in a dedicated computing instance. This prevents comingling of customer data, and allows each instance to be independently managed. For example, when one customer's instance experiences an outage due to errors or an upgrade, other computational instances are not impacted. Maintenance down time is limited because the database only contains one customer's data. Further, the simpler design of the multi-instance architecture allows redundant copies of each customer database and instance to be deployed in a geographically diverse fashion. This facilitates high availability, where the live version of the customer's instance can be moved when faults are detected or maintenance is being performed.

In some embodiments, remote network management platform 320 may include one or more central instances, controlled by the entity that operates this platform. Like a computational instance, a central instance may include some number of application and database nodes disposed upon some number of physical server devices or virtual machines. Such a central instance may serve as a repository for specific configurations of computational instances as well as data that can be shared amongst at least some of the computational instances. For instance, definitions of common security threats that could occur on the computational instances, software packages that are commonly discovered on the computational instances, and/or an application store for applications that can be deployed to the computational instances may reside in a central instance. Computational instances may communicate with central instances by way of well-defined interfaces in order to obtain this data.

In order to support multiple computational instances in an efficient fashion, remote network management platform 320 may implement a plurality of these instances on a single hardware platform. For example, when the aPaaS system is implemented on a server cluster such as server cluster 200, it may operate virtual machines that dedicate varying amounts of computational, storage, and communication resources to instances. But full virtualization of server cluster 200 might not be necessary, and other mechanisms may be used to separate instances. In some examples, each instance may have a dedicated account and one or more dedicated databases on server cluster 200. Alternatively, a computational instance such as computational instance 322 may span multiple physical devices.

In some cases, a single server cluster of remote network management platform 320 may support multiple independent enterprises. Furthermore, as described below, remote network management platform 320 may include multiple server clusters deployed in geographically diverse data centers in order to facilitate load balancing, redundancy, and/or high availability.

### C. Public Cloud Networks

Public cloud networks 340 may be remote server devices (e.g., a plurality of server clusters such as server cluster 200) that can be used for outsourced computation, data storage, communication, and service hosting operations. These servers may be virtualized (i.e., the servers may be virtual machines). Examples of public cloud networks 340 may include Amazon AWS Cloud, Microsoft Azure Cloud (Azure), Google Cloud Platform (GCP), and IBM Cloud Platform. Like remote network management platform 320, multiple server clusters supporting public cloud networks 340 may be deployed at geographically diverse locations for purposes of load balancing, redundancy, and/or high availability.

Managed network 300 may use one or more of public cloud networks 340 to deploy applications and services to its clients and customers. For instance, if managed network 300 provides online music streaming services, public cloud networks 340 may store the music files and provide web interface and streaming capabilities. In this way, the enterprise of managed network 300 does not have to build and maintain its own servers for these operations.

Remote network management platform 320 may include modules that integrate with public cloud networks 340 to expose virtual machines and managed services therein to managed network 300. The modules may allow users to request virtual resources, discover allocated resources, and provide flexible reporting for public cloud networks 340. In order to establish this functionality, a user from managed network 300 might first establish an account with public cloud networks 340, and request a set of associated resources. Then, the user may enter the account information into the appropriate modules of remote network management platform 320. These modules may then automatically discover the manageable resources in the account, and also provide reports related to usage, performance, and billing.

### D. Communication Support and Other Operations

Internet 350 may represent a portion of the global Internet. However, Internet 350 may alternatively represent a different type of network, such as a private wide-area or local-area packet-switched network.

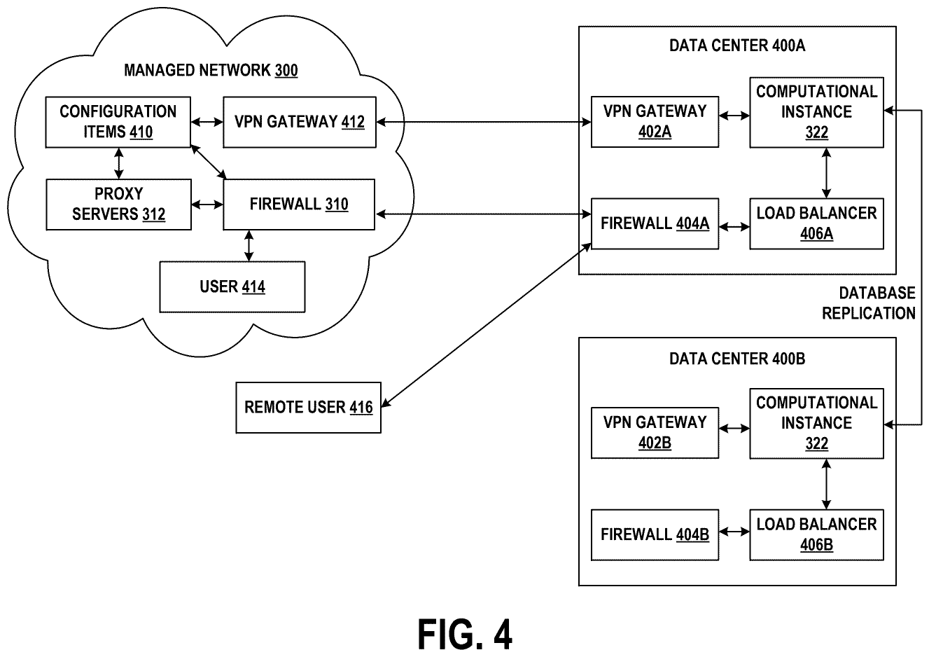

FIG. 4 further illustrates the communication environment between managed network 300 and computational instance 322, and introduces additional features and alternative embodiments. In FIG. 4, computational instance 322 is replicated, in whole or in part, across data centers 400A and 400B. These data centers may be geographically distant from one another, perhaps in different cities or different countries. Each data center includes support equipment that facilitates communication with managed network 300, as well as remote users.

In data center 400A, network traffic to and from external devices flows either through VPN gateway 402A or firewall 404A. VPN gateway 402A may be peered with VPN gateway 412 of managed network 300 by way of a security protocol such as Internet Protocol Security (IPSEC) or Transport Layer Security (TLS). Firewall 404A may be configured to allow access from authorized users, such as user 414 and remote user 416, and to deny access to unauthorized users. By way of firewall 404A, these users may access computational instance 322, and possibly other computational instances. Load balancer 406A may be used to distribute traffic amongst one or more physical or virtual server devices that host computational instance 322. Load balancer 406A may simplify user access by hiding the internal configuration of data center 400A, (e.g., computational instance 322) from client devices. For instance, if computational instance 322 includes multiple physical or virtual computing devices that share access to multiple databases, load balancer 406A may distribute network traffic and processing tasks across these computing devices and databases so that no one computing device or database is significantly busier than the others. In some embodiments, computational instance 322 may include VPN gateway 402A, firewall 404A, and load balancer 406A.

Data center 400B may include its own versions of the components in data center 400A. Thus, VPN gateway 402B, firewall 404B, and load balancer 406B may perform the same or similar operations as VPN gateway 402A, firewall 404A, and load balancer 406A, respectively. Further, by way of real-time or near-real-time database replication and/or other operations, computational instance 322 may exist simultaneously in data centers 400A and 400B.

Data centers 400A and 400B as shown in FIG. 4 may facilitate redundancy and high availability. In the configuration of FIG. 4, data center 400A is active and data center 400B is passive. Thus, data center 400A is serving all traffic to and from managed network 300, while the version of computational instance 322 in data center 400B is being updated in near-real-time. Other configurations, such as one in which both data centers are active, may be supported.

Should data center 400A fail in some fashion or otherwise become unavailable to users, data center 400B can take over as the active data center. For example, domain name system (DNS) servers that associate a domain name of computational instance 322 with one or more Internet Protocol (IP) addresses of data center 400A may re-associate the domain name with one or more IP addresses of data center 400B. After this re-association completes (which may take less than one second or several seconds), users may access computational instance 322 by way of data center 400B.

FIG. 4 also illustrates a possible configuration of managed network 300. As noted above, proxy servers 312 and user 414 may access computational instance 322 through firewall 310. Proxy servers 312 may also access configuration items 410. In FIG. 4, configuration items 410 may refer to any or all of client devices 302, server devices 304, routers 306, and virtual machines 308, any components thereof, any applications or services executing thereon, as well as relationships between devices, components, applications, and services. Thus, the term “configuration items” may be shorthand for part of all of any physical or virtual device, or any application or service remotely discoverable or managed by computational instance 322, or relationships between discovered devices, applications, and services. Configuration items may be represented in a configuration management database (CMDB) of computational instance 322.

As stored or transmitted, a configuration item may be a list of attributes that characterize the hardware or software that the configuration item represents. These attributes may include manufacturer, vendor, location, owner, unique identifier, description, network address, operational status, serial number, time of last update, and so on. The class of a configuration item may determine which subset of attributes are present for the configuration item (e.g., software and hardware configuration items may have different lists of attributes).

As noted above, VPN gateway 412 may provide a dedicated VPN to VPN gateway 402A. Such a VPN may be helpful when there is a significant amount of traffic between managed network 300 and computational instance 322, or security policies otherwise suggest or require use of a VPN between these sites. In some embodiments, any device in managed network 300 and/or computational instance 322 that directly communicates via the VPN is assigned a public IP address. Other devices in managed network 300 and/or computational instance 322 may be assigned private IP addresses (e.g., IP addresses selected from the 10.0.0.0-10.255.255.255 or 192.168.0.0-192.168.255.255 ranges, represented in shorthand as subnets 10.0.0.0/8 and 192.168.0.0/16, respectively). In various alternatives, devices in managed network 300, such as proxy servers 312, may use a secure protocol (e.g., TLS) to communicate directly with one or more data centers.

### V. Example Discovery

In order for remote network management platform 320 to administer the devices, applications, and services of managed network 300, remote network management platform 320 may first determine what devices are present in managed network 300, the configurations, constituent components, and operational statuses of these devices, and the applications and services provided by the devices. Remote network management platform 320 may also determine the relationships between discovered devices, their components, applications, and services. Representations of these devices, components, applications, and services may be referred to as configuration items.

The process of determining the configuration items and relationships therebetween within managed network 300 is referred to as discovery, and may be facilitated at least in part by proxy servers 312. To that point, proxy servers 312 may relay discovery requests and responses between managed network 300 and remote network management platform 320.

Configuration items and relationships may be stored in a CMDB and/or other locations. Further, configuration items may be of various classes that define their constituent attributes and that exhibit an inheritance structure not unlike object-oriented software modules. For instance, a configuration item class of “server” may inherit all attributes from a configuration item class of “hardware” and also include further server-specific attributes. Likewise, a configuration item class of “LINUX® server” may inherit all attributes from the configuration item class of “server” and also include further LINUX®-specific attributes. Additionally, configuration items may represent other components, such as services, data center infrastructure, software licenses, units of source code, configuration files, and documents.

While this section describes discovery conducted on managed network 300, the same or similar discovery procedures may be used on public cloud networks 340. Thus, in some environments, “discovery” may refer to discovering configuration items and relationships on a managed network and/or one or more public cloud networks.

For purposes of the embodiments herein, an “application” may refer to one or more processes, threads, programs, client software modules, server software modules, or any other software that executes on a device or group of devices. A “service” may refer to a high-level capability provided by one or more applications executing on one or more devices working in conjunction with one another. For example, a web service may involve multiple web application server threads executing on one device and accessing information from a database application that executes on another device.

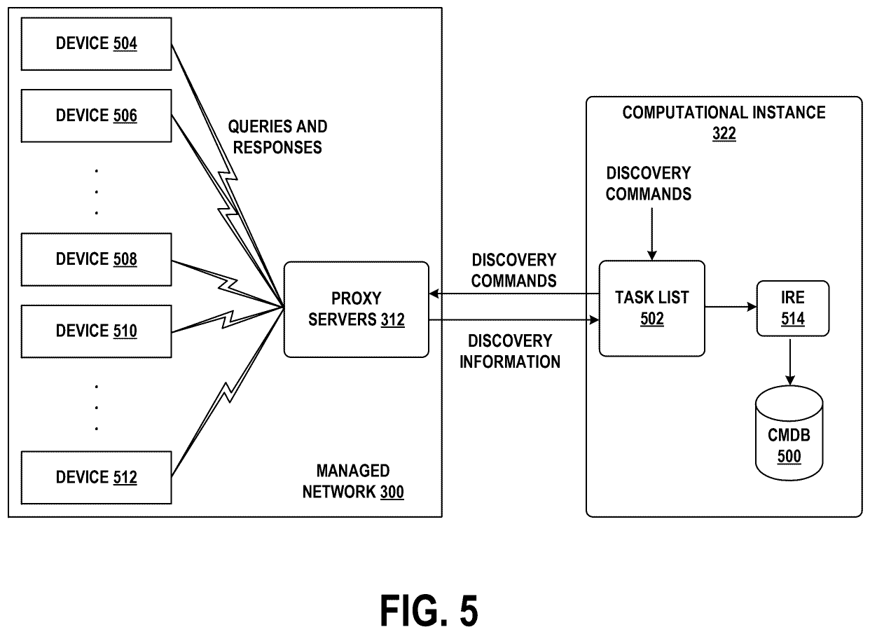

FIG. 5 provides a logical depiction of how configuration items and relationships can be discovered, as well as how information related thereto can be stored. For sake of simplicity, remote network management platform 320, public cloud networks 340, and Internet 350 are not shown.

In FIG. 5, CMDB 500, task list 502, and identification and reconciliation engine (IRE) 514 are disposed and/or operate within computational instance 322. Task list 502 represents a connection point between computational instance 322 and proxy servers 312. Task list 502 may be referred to as a queue, or more particularly as an external communication channel (ECC) queue. Task list 502 may represent not only the queue itself but any associated processing, such as adding, removing, and/or manipulating information in the queue.

As discovery takes place, computational instance 322 may store discovery tasks (jobs) that proxy servers 312 are to perform in task list 502, until proxy servers 312 request these tasks in batches of one or more. Placing the tasks in task list 502 may trigger or otherwise cause proxy servers 312 to begin their discovery operations. For example, proxy servers 312 may poll task list 502 periodically or from time to time, or may be notified of discovery commands in task list 502 in some other fashion. Alternatively or additionally, discovery may be manually triggered or automatically triggered based on triggering events (e.g., discovery may automatically begin once per day at a particular time).

Regardless, computational instance 322 may transmit these discovery commands to proxy servers 312 upon request. For example, proxy servers 312 may repeatedly query task list 502, obtain the next task therein, and perform this task until task list 502 is empty or another stopping condition has been reached. In response to receiving a discovery command, proxy servers 312 may query various devices, components, applications, and/or services in managed network 300 (represented for sake of simplicity in FIG. 5 by devices 504, 506, 508, 510, and 512). These devices, components, applications, and/or services may provide responses relating to their configuration, operation, and/or status to proxy servers 312. In turn, proxy servers 312 may then provide this discovered information to task list 502 (i.e., task list 502 may have an outgoing queue for holding discovery commands until requested by proxy servers 312 as well as an incoming queue for holding the discovery information until it is read).

IRE 514 may be a software module that removes discovery information from task list 502 and formulates this discovery information into configuration items (e.g., representing devices, components, applications, and/or services discovered on managed network 300) as well as relationships therebetween. Then, IRE 514 may provide these configuration items and relationships to CMDB 500 for storage therein. The operation of IRE 514 is described in more detail below.

In this fashion, configuration items stored in CMDB 500 represent the environment of managed network 300. As an example, these configuration items may represent a set of physical and/or virtual devices (e.g., client devices, server devices, routers, or virtual machines), applications executing thereon (e.g., web servers, email servers, databases, or storage arrays), as well as services that involve multiple individual configuration items. Relationships may be pairwise definitions of arrangements or dependencies between configuration items.

In order for discovery to take place in the manner described above, proxy servers 312, CMDB 500, and/or one or more credential stores may be configured with credentials for the devices to be discovered. Credentials may include any type of information needed in order to access the devices. These may include userid/password pairs, certificates, and so on. In some embodiments, these credentials may be stored in encrypted fields of CMDB 500. Proxy servers 312 may contain the decryption key for the credentials so that proxy servers 312 can use these credentials to log on to or otherwise access devices being discovered.

There are two general types of discovery—horizontal and vertical (top-down). Each are discussed below.

### A. Horizontal Discovery

Horizontal discovery is used to scan managed network 300, find devices, components, and/or applications, and then populate CMDB 500 with configuration items representing these devices, components, and/or applications. Horizontal discovery also creates relationships between the configuration items. For instance, this could be a “runs on” relationship between a configuration item representing a software application and a configuration item representing a server device on which it executes. Typically, horizontal discovery is not aware of services and does not create relationships between configuration items based on the services in which they operate.

There are two versions of horizontal discovery. One relies on probes and sensors, while the other also employs patterns. Probes and sensors may be scripts (e.g., written in JAVASCRIPT®) that collect and process discovery information on a device and then update CMDB 500 accordingly. More specifically, probes explore or investigate devices on managed network 300, and sensors parse the discovery information returned from the probes.

Patterns are also scripts that collect data on one or more devices, process it, and update the CMDB. Patterns differ from probes and sensors in that they are written in a specific discovery programming language and are used to conduct detailed discovery procedures on specific devices, components, and/or applications that often cannot be reliably discovered (or discovered at all) by more general probes and sensors. Particularly, patterns may specify a series of operations that define how to discover a particular arrangement of devices, components, and/or applications, what credentials to use, and which CMDB tables to populate with configuration items resulting from this discovery.

Both versions may proceed in four logical phases: scanning, classification, identification, and exploration. Also, both versions may require specification of one or more ranges of IP addresses on managed network 300 for which discovery is to take place. Each phase may involve communication between devices on managed network 300 and proxy servers 312, as well as between proxy servers 312 and task list 502. Some phases may involve storing partial or preliminary configuration items in CMDB 500, which may be updated in a later phase.

In the scanning phase, proxy servers 312 may probe each IP address in the specified range(s) of IP addresses for open Transmission Control Protocol (TCP) and/or User Datagram Protocol (UDP) ports to determine the general type of device and its operating system. The presence of such open ports at an IP address may indicate that a particular application is operating on the device that is assigned the IP address, which in turn may identify the operating system used by the device. For example, if TCP port 135 is open, then the device is likely executing a WINDOWS® operating system. Similarly, if TCP port 22 is open, then the device is likely executing a UNIX® operating system, such as LINUX®. If UDP port 161 is open, then the device may be able to be further identified through the Simple Network Management Protocol (SNMP). Other possibilities exist.

In the classification phase, proxy servers 312 may further probe each discovered device to determine the type of its operating system. The probes used for a particular device are based on information gathered about the devices during the scanning phase. For example, if a device is found with TCP port 22 open, a set of UNIX®-specific probes may be used. Likewise, if a device is found with TCP port 135 open, a set of WINDOWS®-specific probes may be used. For either case, an appropriate set of tasks may be placed in task list 502 for proxy servers 312 to carry out. These tasks may result in proxy servers 312 logging on, or otherwise accessing information from the particular device. For instance, if TCP port 22 is open, proxy servers 312 may be instructed to initiate a Secure Shell (SSH) connection to the particular device and obtain information about the specific type of operating system thereon from particular locations in the file system. Based on this information, the operating system may be determined. As an example, a UNIX® device with TCP port 22 open may be classified as AIX®, HPUX, LINUX®, MACOS®, or SOLARIS®. This classification information may be stored as one or more configuration items in CMDB 500.

In the identification phase, proxy servers 312 may determine specific details about a classified device. The probes used during this phase may be based on information gathered about the particular devices during the classification phase. For example, if a device was classified as LINUX®, a set of LINUX®-specific probes may be used. Likewise, if a device was classified as WINDOWS® 10, as a set of WINDOWS®-10-specific probes may be used. As was the case for the classification phase, an appropriate set of tasks may be placed in task list 502 for proxy servers 312 to carry out. These tasks may result in proxy servers 312 reading information from the particular device, such as basic input/output system (BIOS) information, serial numbers, network interface information, media access control address(es) assigned to these network interface(s), IP address(es) used by the particular device and so on. This identification information may be stored as one or more configuration items in CMDB 500 along with any relevant relationships therebetween. Doing so may involve passing the identification information through IRE 514 to avoid generation of duplicate configuration items, for purposes of disambiguation, and/or to determine the table(s) of CMDB 500 in which the discovery information should be written.

In the exploration phase, proxy servers 312 may determine further details about the operational state of a classified device. The probes used during this phase may be based on information gathered about the particular devices during the classification phase and/or the identification phase. Again, an appropriate set of tasks may be placed in task list 502 for proxy servers 312 to carry out. These tasks may result in proxy servers 312 reading additional information from the particular device, such as processor information, memory information, lists of running processes (software applications), and so on. Once more, the discovered information may be stored as one or more configuration items in CMDB 500, as well as relationships.

Running horizontal discovery on certain devices, such as switches and routers, may utilize SNMP. Instead of or in addition to determining a list of running processes or other application-related information, discovery may determine additional subnets known to a router and the operational state of the router's network interfaces (e.g., active, inactive, queue length, number of packets dropped, etc.). The IP addresses of the additional subnets may be candidates for further discovery procedures. Thus, horizontal discovery may progress iteratively or recursively.

Patterns are used only during the identification and exploration phases—under pattern-based discovery, the scanning and classification phases operate as they would if probes and sensors are used. After the classification stage completes, a pattern probe is specified as a probe to use during identification. Then, the pattern probe and the pattern that it specifies are launched.

Patterns support a number of features, by way of the discovery programming language, that are not available or difficult to achieve with discovery using probes and sensors. For example, discovery of devices, components, and/or applications in public cloud networks, as well as configuration file tracking, is much simpler to achieve using pattern-based discovery. Further, these patterns are more easily customized by users than probes and sensors. Additionally, patterns are more focused on specific devices, components, and/or applications and therefore may execute faster than the more general approaches used by probes and sensors.

Once horizontal discovery completes, a configuration item representation of each discovered device, component, and/or application is available in CMDB 500. For example, after discovery, operating system version, hardware configuration, and network configuration details for client devices, server devices, and routers in managed network 300, as well as applications executing thereon, may be stored as configuration items. This collected information may be presented to a user in various ways to allow the user to view the hardware composition and operational status of devices.

Furthermore, CMDB 500 may include entries regarding the relationships between configuration items. More specifically, suppose that a server device includes a number of hardware components (e.g., processors, memory, network interfaces, storage, and file systems), and has several software applications installed or executing thereon. Relationships between the components and the server device (e.g., “contained by” relationships) and relationships between the software applications and the server device (e.g., “runs on” relationships) may be represented as such in CMDB 500.

More generally, the relationship between a software configuration item installed or executing on a hardware configuration item may take various forms, such as “is hosted on”, “runs on”, or “depends on”. Thus, a database application installed on a server device may have the relationship “is hosted on” with the server device to indicate that the database application is hosted on the server device. In some embodiments, the server device may have a reciprocal relationship of “used by” with the database application to indicate that the server device is used by the database application. These relationships may be automatically found using the discovery procedures described above, though it is possible to manually set relationships as well.

In this manner, remote network management platform 320 may discover and inventory the hardware and software deployed on and provided by managed network 300.

### B. Vertical Discovery

Vertical discovery is a technique used to find and map configuration items that are part of an overall service, such as a web service. For example, vertical discovery can map a web service by showing the relationships between a web server application, a LINUX® server device, and a database that stores the data for the web service. Typically, horizontal discovery is run first to find configuration items and basic relationships therebetween, and then vertical discovery is run to establish the relationships between configuration items that make up a service.

Patterns can be used to discover certain types of services, as these patterns can be programmed to look for specific arrangements of hardware and software that fit a description of how the service is deployed. Alternatively or additionally, traffic analysis (e.g., examining network traffic between devices) can be used to facilitate vertical discovery. In some cases, the parameters of a service can be manually configured to assist vertical discovery.

In general, vertical discovery seeks to find specific types of relationships between devices, components, and/or applications. Some of these relationships may be inferred from configuration files. For example, the configuration file of a web server application can refer to the IP address and port number of a database on which it relies. Vertical discovery patterns can be programmed to look for such references and infer relationships therefrom. Relationships can also be inferred from traffic between devices—for instance, if there is a large extent of web traffic (e.g., TCP port 80 or 8080) traveling between a load balancer and a device hosting a web server, then the load balancer and the web server may have a relationship.

Relationships found by vertical discovery may take various forms. As an example, an email service may include an email server software configuration item and a database application software configuration item, each installed on different hardware device configuration items. The email service may have a “depends on” relationship with both of these software configuration items, while the software configuration items have a “used by” reciprocal relationship with the email service. Such services might not be able to be fully determined by horizontal discovery procedures, and instead may rely on vertical discovery and possibly some extent of manual configuration.

### C. Advantages of Discovery

Regardless of how discovery information is obtained, it can be valuable for the operation of a managed network. Notably, IT personnel can quickly determine where certain software applications are deployed, and what configuration items make up a service. This allows for rapid pinpointing of root causes of service outages or degradation. For example, if two different services are suffering from slow response times, the CMDB can be queried (perhaps among other activities) to determine that the root cause is a database application that is used by both services having high processor utilization. Thus, IT personnel can address the database application rather than waste time considering the health and performance of other configuration items that make up the services.

In another example, suppose that a database application is executing on a server device, and that this database application is used by an employee onboarding service as well as a payroll service. Thus, if the server device is taken out of operation for maintenance, it is clear that the employee onboarding service and payroll service will be impacted. Likewise, the dependencies and relationships between configuration items may be able to represent the services impacted when a particular hardware device fails.

In general, configuration items and/or relationships between configuration items may be displayed on a web-based interface and represented in a hierarchical fashion. Modifications to such configuration items and/or relationships in the CMDB may be accomplished by way of this interface.

Furthermore, users from managed network 300 may develop workflows that allow certain coordinated activities to take place across multiple discovered devices. For instance, an IT workflow might allow the user to change the common administrator password to all discovered LINUX® devices in a single operation.

### VI. CMDB Identification Rules and Reconciliation

A CMDB, such as CMDB 500, provides a repository of configuration items and relationships. When properly provisioned, it can take on a key role in higher-layer applications deployed within or involving a computational instance. These applications may relate to enterprise IT service management, operations management, asset management, configuration management, compliance, and so on.

For example, an IT service management application may use information in the CMDB to determine applications and services that may be impacted by a component (e.g., a server device) that has malfunctioned, crashed, or is heavily loaded. Likewise, an asset management application may use information in the CMDB to determine which hardware and/or software components are being used to support particular enterprise applications. As a consequence of the importance of the CMDB, it is desirable for the information stored therein to be accurate, consistent, and up to date.

A CMDB may be populated in various ways. As discussed above, a discovery procedure may automatically store information including configuration items and relationships in the CMDB. However, a CMDB can also be populated, as a whole or in part, by manual entry, configuration files, and third-party data sources. Given that multiple data sources may be able to update the CMDB at any time, it is possible that one data source may overwrite entries of another data source. Also, two data sources may each create slightly different entries for the same configuration item, resulting in a CMDB containing duplicate data. When either of these occurrences takes place, they can cause the health and utility of the CMDB to be reduced.

In order to mitigate this situation, these data sources might not write configuration items directly to the CMDB. Instead, they may write to an identification and reconciliation application programming interface (API) of IRE 514. Then, IRE 514 may use a set of configurable identification rules to uniquely identify configuration items and determine whether and how they are to be written to the CMDB.

In general, an identification rule specifies a set of configuration item attributes that can be used for this unique identification. Identification rules may also have priorities so that rules with higher priorities are considered before rules with lower priorities. Additionally, a rule may be independent, in that the rule identifies configuration items independently of other configuration items. Alternatively, the rule may be dependent, in that the rule first uses a metadata rule to identify a dependent configuration item.

Metadata rules describe which other configuration items are contained within a particular configuration item, or the host on which a particular configuration item is deployed. For example, a network directory service configuration item may contain a domain controller configuration item, while a web server application configuration item may be hosted on a server device configuration item.

A goal of each identification rule is to use a combination of attributes that can unambiguously distinguish a configuration item from all other configuration items, and is expected not to change during the lifetime of the configuration item. Some possible attributes for an example server device may include serial number, location, operating system, operating system version, memory capacity, and so on. If a rule specifies attributes that do not uniquely identify the configuration item, then multiple components may be represented as the same configuration item in the CMDB. Also, if a rule specifies attributes that change for a particular configuration item, duplicate configuration items may be created.

Thus, when a data source provides information regarding a configuration item to IRE 514, IRE 514 may attempt to match the information with one or more rules. If a match is found, the configuration item is written to the CMDB or updated if it already exists within the CMDB. If a match is not found, the configuration item may be held for further analysis.

Configuration item reconciliation procedures may be used to ensure that only authoritative data sources are allowed to overwrite configuration item data in the CMDB. This reconciliation may also be rules-based. For instance, a reconciliation rule may specify that a particular data source is authoritative for a particular configuration item type and set of attributes. Then, IRE 514 might only permit this authoritative data source to write to the particular configuration item, and writes from unauthorized data sources may be prevented. Thus, the authorized data source becomes the single source of truth regarding the particular configuration item. In some cases, an unauthorized data source may be allowed to write to a configuration item if it is creating the configuration item or the attributes to which it is writing are empty.

Additionally, multiple data sources may be authoritative for the same configuration item or attributes thereof. To avoid ambiguities, these data sources may be assigned precedences that are taken into account during the writing of configuration items. For example, a secondary authorized data source may be able to write to a configuration item's attribute until a primary authorized data source writes to this attribute. Afterward, further writes to the attribute by the secondary authorized data source may be prevented.

In some cases, duplicate configuration items may be automatically detected by IRE 514 or in another fashion. These configuration items may be deleted or flagged for manual de-duplication.

### VII. Example Platform Applications

As noted, remote network management platform 320 may support a number of applications and services, each of which may use or involve information from CMDB 500 and/or other databases as needed. Some of these applications and services may include task-based applications, workflows, user interface building tools, and agent interfaces, just to name a few. Other applications and services not explicitly discussed herein may benefit from the disclosed embodiments. Nonetheless, these task-based applications, workflows, user interface building tools, and agent interfaces are briefly described below to provide context for example embodiments of software that has user interfaces that could be enhanced by natural language model interactions.

### A. Task-Based Applications

Remote network management platform 320 may furnish various IT service management (ITSM) solutions including task-based applications designed to streamline and manage specific processes. Three examples are incident management, case management, and problem management.

Incident management focuses on the efficient resolution of IT service disruptions or incidents. When an issue or disruption occurs, it is logged as an incident in the incident management application. This application allows IT teams to track and manage these incidents throughout their lifecycles. It includes features such as incident creation/generation, assignment, prioritization, escalation, communication, and resolution. The incident management application provides workflows, notifications, and collaboration tools to facilitate the prompt and efficient addressing of incidents, with a goal of minimizing their impact on platform and system operations.

Case management is designed to handle diverse types of processes, requests, or workflows. It enables users to manage complex cases that require coordination across multiple groups. The case management application provides a unified platform to capture, track, and manage cases from initiation to resolution. It includes features such as case creation, classification, assignment, task tracking, collaboration, and closure. This application can be tailored to various use cases, such as HR inquiries, legal matters, facilities management, and customer support escalations among others.

Problem management is drawn to identifying and addressing the root causes of recurring incidents or issues. It helps IT teams identify underlying problems that lead to multiple incidents, analyze their impact, and initiate appropriate actions for resolution. The problem management application provides tools for problem identification, investigation, prioritization, and tracking. It allows users to link related incidents, perform root cause analysis, define workarounds or solutions, and track the progress of problem resolution. The application helps groups minimize the occurrence and impact of recurring issues, leading to improved service quality and stability for the platform and other systems.

### B. Workflows

As noted, task-based applications may employ or be integrated with workflows in some fashion. Here, a workflow defines a sequence of activities and operations used to automate and streamline processes. These workflows may include conditions and branching logic, enabling different paths within the workflow based on specific criteria, such as the values or states of variables or data.

Workflows can be integrated with other applications operable on remote network management platform 320, such as the task-based applications described above. This integration enables cross-application coordination and process synchronization. Further, remote network management platform 320 can integrate workflows with external systems and applications through web services or API calls. This allows for data exchange and collaboration with third-party tools, enabling end-to-end process automation and information sharing.

Remote network management platform 320 may include a workflow designer application that allows users to create, modify, and manage workflows using a drag-and-drop user interface. The application provides a graphical representation of the workflow, making it easier to understand and configure the ordering of activities in the workflow. The application may also provide pre-built workflow templates and libraries that offer ready-to-use workflows for common processes. These templates can be customized to meet specific needs, thus accelerating the implementation of workflows.

### C. User Interface Building Tools

Remote network management platform 320 may provide a user interface builder application that is a visual design tool for creating and customizing user interfaces within the platform. This application may employ a low-code/no-code approach to designing intuitive graphical user interfaces, enabling administrators and developers to build user interface components without extensive coding knowledge.

Notably, low-code/no-code design refers to a development approach that enables the creation of software applications with minimal or no coding required. It involves using visual interfaces, drag-and-drop components, and declarative configuration instead of writing traditional lines of code.

Low-code platforms can provide a visual development environment that allows users to design and build applications through graphical interfaces, pre-built components, and configuration options. They typically offer a set of pre-built functionalities and connectors to integrate with external systems, databases, and services. No-code platforms take the concept of low-code a step further by enabling users with little to no programming experience to create applications. These platforms offer a highly visual and intuitive interface where users can build applications using simple drag-and-drop actions, visual workflows, and configuration options. No-code platforms often provide a library of pre-built templates, modules, and integrations, allowing users to assemble and customize applications without writing any code.

Both low-code and no-code approaches aim to simplify and streamline the software development process, making it accessible to a broader range of users, including analysts, new developers, and subject matter experts. These approaches can empower non-technical users to create functional and scalable applications, reduce the reliance on traditional coding, and accelerate the development lifecycle.

To that point, the user interface builder application may include a drag-and-drop interface that simplifies the process of creating user interfaces. Users can add and arrange user interface components such as fields, buttons, containers, tables, and images onto the canvas, eliminating the need for manual coding. In doing so, the application may rely on a library of pre-built user interface components that users can choose from, including form fields, widgets, buttons, and navigation elements. These components can be added to the canvas and customized according to specific needs.

These user interface components may be bound to data sources within remote network management platform 320. This enables dynamic data display, real-time updates, and synchronization between the user interface and underlying data. The application also allows integration with other applications and workflows, as well as the use of conditional logic (e.g., visibility rules, triggering of actions, etc.) to create interactive and context-aware user interfaces.

### D. Virtual Agents

Remote network management platform 320 may also support virtual agents. These can be artificial-intelligence powered conversational interfaces designed to interact with users and provide automated assistance. Virtual agents can be integrated into various interfaces and applications, such as web portals, chat interfaces, and messaging platforms to offer self-service options and enhance the user experience. The virtual agents operable on remote network management platform 320 are different from the virtual agent features of a large language model (LLM). Notably, platform virtual agents may employ LLMs in some situations, but can also operate based on local platform content and pre-defined dialog trees, for example.

Virtual agents can engage in dynamic and context-rich conversations with users. They can guide users through predefined conversation flows, prompt for information, ask clarifying questions, and provide relevant responses or recommendations based on the user's needs. These virtual agents can be integrated with a knowledgebase, which contains a repository of articles, frequently-asked questions (FAQs), and troubleshooting information. Virtual agents can access this knowledgebase to retrieve relevant information and provide self-help resources to users. Virtual agents can also automate common tasks or processes within the platform. They can initiate workflows, create tasks, perform system actions, or provide status updates, allowing users to complete tasks without manual intervention.

Further, virtual agents can transfer conversations to live (human) agents when necessary or desirable. If a virtual agent cannot resolve a user's query or if the user requests human assistance, the conversation can be handed off to a live agent for further support and resolution. Such a handoff may involve providing, to the live agent, the context (and possibly some or all of the content) of the conversation between the user and the virtual agent.

### VIII. Configuration Data

As described above, a remote network management platform (such as remote network management platform 320) may support a vast array of software applications and services. Each of these may have its own configuration data, which could reside by default in one or more files or database entries within or outside of the platform.

The configuration data may be made up of sets of parameters, where a parameter may be a key-value pair, one or more alphanumeric values, a file, or some other type of content. For purposes of discussion herein, it may be assumed that parameters take the form of key-value pairs but other parameter forms may be employed. An example of a key-value pair is “ip-address: 10.0.177.15”, where the key is the text “ip-address” and the value is the IP address “10.0.177.15”. Key-value pairs can be stored in various types of structured or unstructured text files, database tables, and so on.

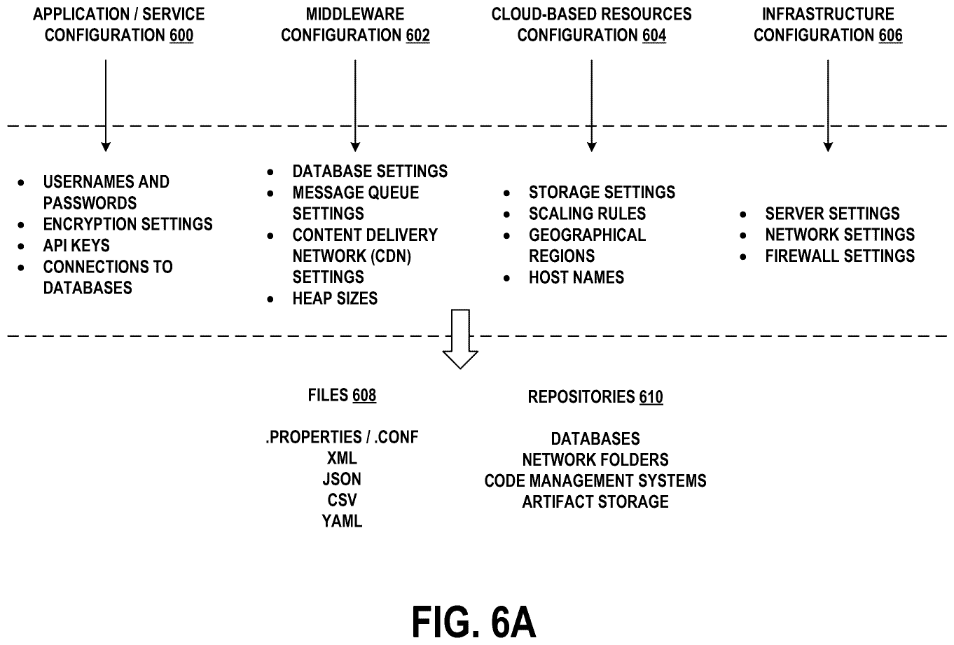

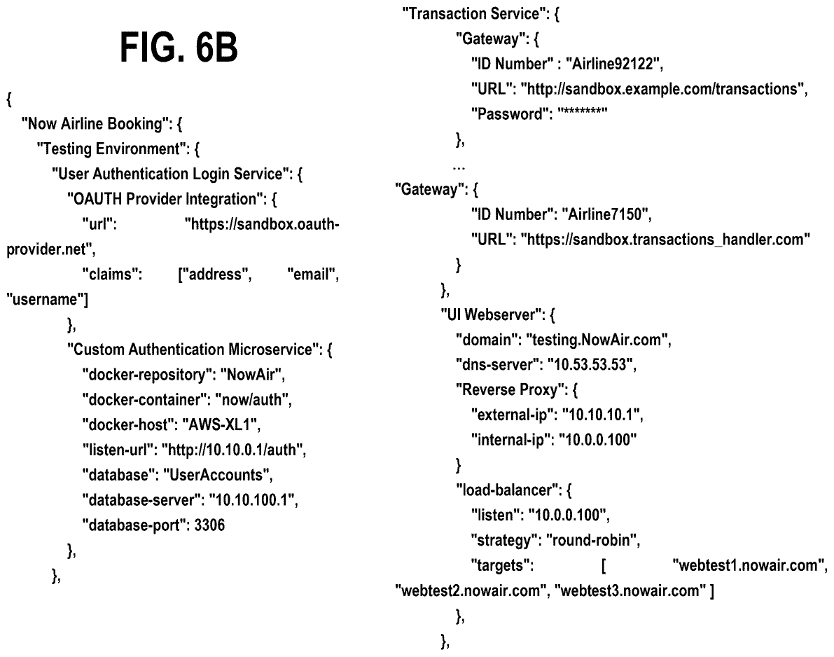

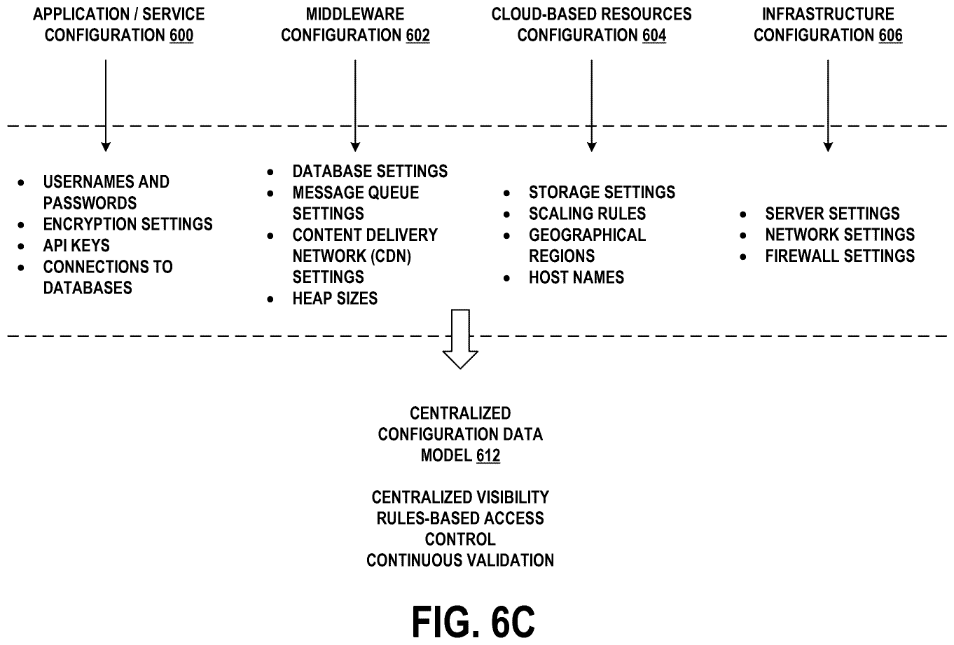

FIG. 6A illustrates an example of types of configuration data, as well as how and where it might be stored. Application/service configuration 600 may include configuration data for specific software applications and/or services. These may be one or more of usernames and passwords, encryption settings, API keys, or connections to databases. Middleware configuration 602 may include configuration data of features built into the remote network management platform that may be employed by the software applications and/or services. These may be one or more of database settings, message queue settings, content delivery network (CDN) settings, and/or heap sizes. Cloud-based resources configuration 604 may include configuration data relating to one or more public cloud network services used by the software applications and/or services. These may be one or more of storage settings, scaling rules (e.g., for processing, storage, and network capacity), geographical regions in which the cloud-based resources are located, and/or host names relating to these resources. Infrastructure configuration 606 may include configuration data directed to the operation of computing devices within the remote network management platform. These may be one or more of server device settings, network settings, firewall settings, and so on. For instance, these settings may include IP address assignments, domain name assignments, workgroup assignments, etc.

This configuration data may be stored in different ways spread across the remote network management platform, one or more public cloud networks, and/or other locations. For example, some of this configuration data may be stored in files 608, which may include unstructured text, structured text, or be other types of files—e.g., . properties, .conf, XML, JSON, comma-separated-value (CSV), and/or Yet Another Markup Language (YAML) files. Alternatively or additionally, some of this configuration data (parameters and/or files) may be stored in repositories 610, which may include databases (e.g., specific database tables), network folders, source code management systems, and/or artifact storage.

In some cases, configuration data may be stored in a hierarchical tree-like structure. For instance, JSON and XML files are hierarchically structured in a fashion that is directly analogous to a tree. In these types of files, objects are either an element (e.g., a key-value pair that is like a leaf of a tree) or a container of other objects (e.g., a block of elements that is like a root or intermediate node in a tree).

As a concrete example, an airline booking web site can contain many nodes of application and service configuration data, such as a custom ticket reservation application, a user relations management component, a transaction gateway service, a user interface, a series of webservers that provide content to the user interface, authentication microservices, database servers, load balancers, and internal network routing policies that all need to be configured properly in order to combine and operate seamlessly as the airline booking application service. As such, the configuration data of a software service may be extensive and number in the thousands of nodes storing tens of thousands of configuration key-value pairs in a tree-like hierarchy. A simplified example set of JSON configuration for such a software service is shown in FIG. 6B.

The challenges of maintaining such configuration data is not only that the data is complex (tens of thousands to millions of parameters), but also that changes to it are frequent. For example, a remote network management platform may support hundreds or thousands of software applications and services, some fraction of which may be under continuous development processes, such as various types of agile programming models. As such, new versions of these applications may be deployed into a production environment every few days, or even several times in one day.

The teams of software engineers developing and testing these applications may make changes to the configuration data of their applications, but may also modify that of other applications, as well as that of middleware and/or infrastructure. Thus, to fix a software defect or to deploy a new feature, one team of software engineers may make changes to configuration data that affects the software applications of some or all other teams. Such changes may cause at least some of these other software applications to change behavior or to fail in various ways.

Further, each set of configuration data may be placed in files 608 and/or repositories 610 that are disposed throughout numerous locations. This leads to weak access restrictions for configuration data and the coordination of changes being difficult if not impossible. The result is that changes can be uncontrolled, can have no traceability, and cannot be easily audited.

As a consequence, a major root cause of software application and service outages is now errors in configuration data. In some estimates, these errors are even more prevalent and more impactful than coding errors in the software applications. Some notable configuration-related outages have taken entire web sites offline or rendered them impractical to use for hours or even days. Due to the aforementioned limitations, these outages are difficult to troubleshoot because narrowing down the configuration changes that may have caused the outage is akin to looking for a needle in a haystack across multiple files and repositories.

Therefore, any improvement in how configuration data is managed, presented, viewed, and manipulated such that outages are less likely to occur and faster to resolve would be beneficial.

The embodiments herein provide such improvements. As shown in FIG. 6C, the embodiments may involve consolidating the configuration data into a centralized configuration data model 612, which may be stored in a single location. This facilitates centralized visibility into configuration data (so that software engineers and operations engineers do not have to spend inordinate amounts of time just to find relevant files or repositories). This also facilitates rule-based access control, in which sets of access control lists (ACLs) or other mechanisms define which users can make what changes to certain parameters at what points in time. This further facilitates continuous validation in which automated processes scan the configuration data to identify possible errors, misconfigurations, or inconsistent groups of parameters. Such validation may be based on rules that define valid and/or invalid parameters or combinations of parameters, or based on logic that is more complex.

One or more such ACLs may also control the visibility to nodes, keys, or values on a per-user or per-user-group basis. As a result, some users may be unable to view certain branches in the tree, or to observe certain masked values (like passwords) while still maintaining the ability to know that the masked value was added, edited, deleted, or remains unchanged.

A version of the configuration data may be referred to as a snapshot. Modifications to the configuration data may be gated by change requests, where these change requests specify the files, database entries, and/or other structures impacted by each change. This allows a timeline of changes to be generated from the snapshots, and differences between the parameters of the snapshots to be determined based on the change requests. Such differences may be displayed in a tree-like hierarchy with additions, deletions, and modifications (edits) from one snapshot to another clearly indicated. Sets of such differences are referred to herein as changesets and may be associated with change requests. Advantageously, configuration faults can be quickly identified and triaged without having to examine thousands of parameters in numerous locations.

As noted above, snapshots refer to versions of the configuration data. In some cases, a snapshot may refer to the entirety of the configuration data, and in others only a subset of the configuration data (e.g., the part of the configuration data used by one or more specific software applications).

As an example, suppose that a particular software application includes parameters in the configuration data that determine which search engine is to be employed for user search requests. It may be desirable to support multiple search engines and have the software application be able to use or switch between any of them.

In possible embodiments, the parameters may be updated to include a new search engine. For example, parameters to specify the Google search engine may include the following key-value pairs: “googleSearch: disabled”, “googleSearchURL: www.google.com”, and “googleRefIdNumber: grefID123113”.

First, a change request may be made, asking for the new search engine to be added. This change request may come from a user or an application, and may be added to a database of change requests stored by the remote network management platform. Based on this change request, a software developer may add the new parameters to a configuration file of the software application. Next, a new version of the software application is built, incorporating these parameters into its configuration file, as well as any changes to the code of the software application that facilitates use of the new search engine. Then, the package (e.g., the new versions of application and its configuration data) may undergo automated testing procedures. Such testing may involve making sure that the configuration file is syntactically correct and properly formatted.

Assuming that these tests pass, the configuration file may be uploaded to centralized configuration data model 612. A snapshot of the configuration file is made, where the snapshot is the current version of the configuration file. The snapshot goes through a validation process and is then published (made available) by way of a web interface of centralized configuration data model 612.

After the snapshot is available, a change control process is undertaken to review and either approve or reject the change request (as well as the associated changeset and snapshot). The change control process may include manual review from a software developer or automated review. For example, the results of the validation process may be reviewed to ensure that validation was successful. Once the change request is approved, the package can be deployed into an environment (e.g., production use by end users of the remote network management platform, testing use by software testers, or development use by software developers).

### IX. Threat Analysis Using Generative Artificial Intelligence

Other applications of the remote network management platform may involve the development of other platform applications using workflows and other tools as described above.

### A. Threat Modeling

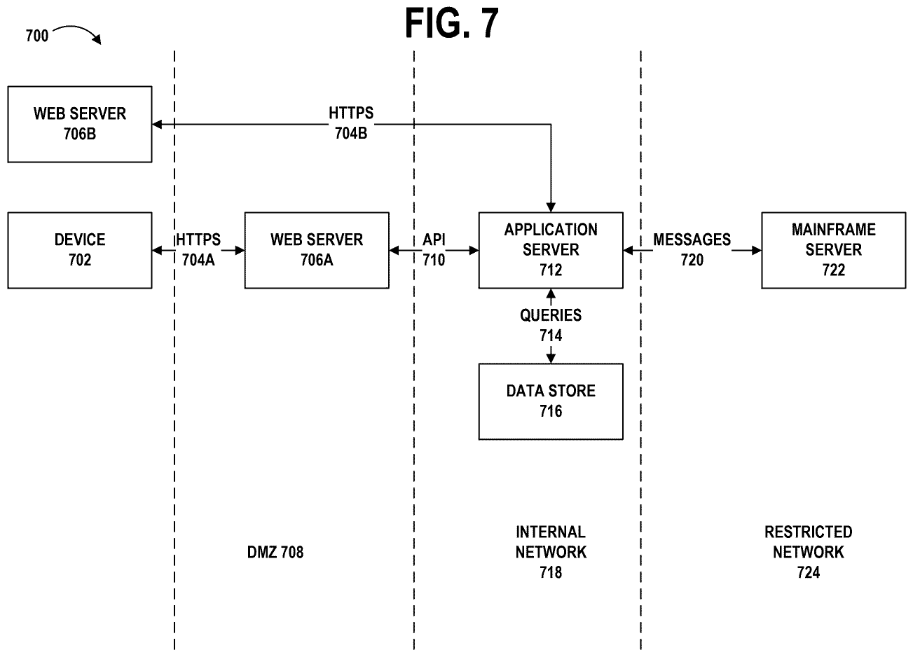

During the software development process, threat models are often developed to contain and display information pertaining to the security of an application. In general, a threat model includes directed graphs depicting the relationships between different components (software or hardware) involved in the functioning of an application. An example threat model 700 is illustrated in FIG. 7.

The threat model 700 depicts several components involved in the functioning of an example web-based application. These components may include a device 702, web servers 706A and 706B, application server 712, data store 716, and mainframe server 722. The components may be organized into different hierarchical zones or trust levels depending how restricted access is to those components. In FIG. 7, this is represented by the “demilitarized zone” DMZ 708, internal network 728, and restricted network 724.

Relationships (e.g., communications) between components within the threat model 700 are represented using arrows. As shown, the device 702 may communicate with the web server 706 using Hypertext Transfer Protocol Secure (HTTPS) 704A. The web server 706 is shown as within the DMZ 708, a heightened-security network zone that represents the “border” between the internal network 718 and the wider networks to which the device 702 may be connected. The DMZ 708 may thus act as a filter for certain types of network traffic entering the internal network 718.

The web server 706 may communicate with the application server 712 through the use of an application programming interface (API) 710. The application server 712 may also communicate via queries 714 to the data store 716. The application server 712 and data store 716 are shown as within the internal network 718, a network with a higher level of security than the DMZ 708. Thus, access to the internal network 718 is restricted further than the DMZ 708.

The application server 712 may communicate with other “downstream” web servers located on the broader Internet or external networks (i.e., not in the DMZ 708, internal network 728, or restricted network 724). This may occur through HTTPS 704B, as shown, or any other type of communication protocol.

The application server 712 may communicate with the mainframe server 722 through messages 720. This could be a messaging protocol, other communication protocol, or job scheduling service. The mainframe server 722 is shown as within the restricted network 724, a network with a higher level of security than the internal network 718, and thus has a higher level of security. This may occur for several different reasons; for instance, the mainframe server 722 may handle sensitive and/or personally identifying information.

Each of the relationships/communications outlined above (HTTPS 704A and 704B, API 710, queries 714, and messages 720) between the different components in the threat model 700 (the device 702, web servers 706A and 706B, application server 712, data store 716, and mainframe server 722) that are within different trust levels (DMZ 708, internal network 718, and restricted network 724) are illustrated within the threat model 700, and can be used to identify threats and/or vulnerabilities to the components. For instance, a vulnerability identified in HTTPS may impact the web server 706, while an API exploit could enable unauthorized access to the application server 712 and/or internal network 718.

In some embodiments, the components included in the threat model 700 may represent software functions and/or programs within an application.

Further, as components and relationships are modified, or as new components and relationships are added to the threat model, these identified threats and/or vulnerabilities may change. A system involving the use of a threat model for identifying and addressing vulnerabilities through changes is described below.

### B. Version Control and Change Analysis Systems

During the development of applications such as those described above, source code and/or configuration data may be stored in a version control system (VCS). Examples include Git and Fossil, and often involve the tracking of changes made to the source code or configuration data and ensuring that changes made to source code or configuration data are mirrored among all copies of the source code or configuration data, even if those copies are stored on different devices or systems.

In particular, VCSes may have the capability to record change events, discrete steps containing changes to code or configuration data made since the last step. This disclosure presents a change analysis system that may integrate with VCSes and use the application's threat model in order to identify problems within the source code or configuration data.

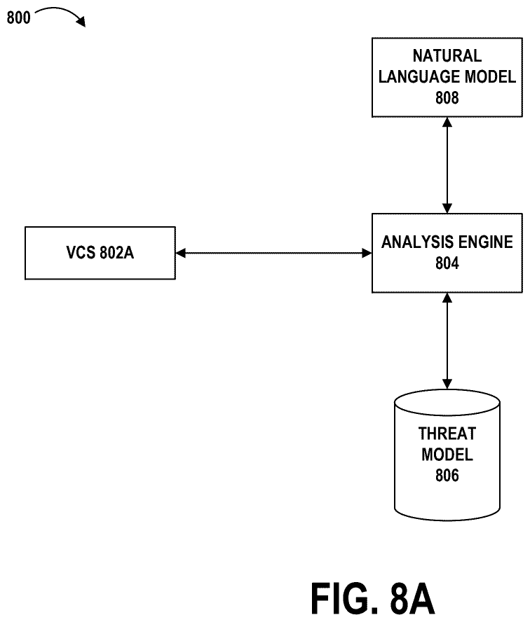

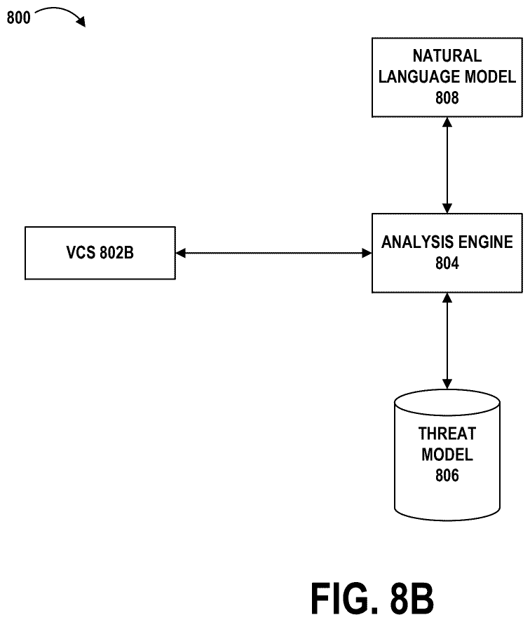

FIG. 8A depicts an example change analysis system 800, in accordance with example embodiments. The change analysis system 800 may include a VCS 802A, analysis engine 804, threat model 806, and natural language model 808.

The VCS 802A, as described above, may track changes made to source code related to an application. The changes themselves may be stored as change events, which may include the differences between one version of source code and another. For instance, a change event may include added lines of code in comparison to a previous version of source code that did not include the added lines. The differences between different versions of source code may be referred to as “deltas.”

The analysis engine 804 may include an application configured to analyze change events and/or source code from the VCS 802A. It may do so by using the threat model 806. The analysis engine 804 may include a search module (e.g., for performing semantic or other types of searches), text parser, or any other type of text search or analysis tool now known or later discovered. The analysis engine 804 may also include a natural language model, as described below.

The threat model 806 may be any type of threat model, including the threat model 700 described above. The threat model 806 contains information (or representations) related to relationships and components within the context of an application, and this information may be used by the analysis engine 804 to identify threats or vulnerabilities that may occur as a result of implementing the changes described in a change event. For instance, the threat model 806 may include a directed graph or similar structure that represents components as nodes and relationships as edges.

In such a situation, the analysis engine 804 may use any type of graph-traversal algorithm or similar process to search the threat model 806 in order to identify components or relationships related to the change event provided by the VCS 802A. For instance, if a change event related to an API, the analysis engine 804 may search the threat model 806 for components and relationships connected to the API. For instance, an API used between a server and a client device may be represented within the threat model 806 as two nodes connected by one or more edges. The threat model 806 may also include additional information related to the nodes and/or edges, such as description text or sample code, that may also aid the analysis engine 804 in its searching process. Based on this information from the threat model 806 and the change event, the analysis engine 804 may then be able to identify vulnerabilities, threats, or other security risks that may arise as a result of implementing the changes. For instance, using the API example, the analysis engine 804 may determine that a change event would modify an edge of the API in the threat model in a way that would allow unauthorized access to the server, and thus identify such a vulnerability in that way.

The natural language model 808 may be any sort of natural language or similar type of machine learning model. Natural language models are machine learning systems trained to understand, generate, and/or predict human language by learning patterns from large datasets of text and possibly other sources. These models can perform tasks like translation, summarization, question answering, and/or conversation. A large language model (LLM) is an advanced natural language model, configured to understand, interpret, generate, and respond to human language in a manner that is both contextually relevant and syntactically coherent, allowing even colloquial conversation between a human user and the model.

The underlying structure of an LLM is typically based on a neural network architecture, more specifically, a variant of the transformer model. Transformers are notable for their ability to process sequential data, such as text, with high efficiency. LLM operation involves passing data through layers of interconnected processing units, known as neurons, which collectively form a deep neural network. This network can be trained on vast datasets comprising text from diverse sources, thereby enabling the LLM to learn a wide array of language patterns, structures, and colloquial nuances for prose, poetry, and program code. The training process involves adjusting the weights of the connections between neurons using algorithms such as backpropagation, in conjunction with optimization techniques like stochastic gradient descent, to minimize the difference between the LLM's output and expected output.

An aspect of an LLM's functionality is its use of attention mechanisms, particularly self-attention, within the transformer architecture. These mechanisms allow the model to weigh the importance of different parts of the input text differently, enabling it to focus on relevant aspects of the data when generating responses or analyzing language. The self-attention mechanism facilitates the model's ability to generate contextually relevant and coherent text by understanding the relationships and dependencies between words or tokens in a sentence (or longer parts of texts), regardless of their position.

Upon receiving an input, such as a text query or a prompt, the LLM may process this input through its multiple layers, generating a probabilistic model of the language therein. It predicts the likelihood of each word or token that might follow the given input, based on the patterns it has learned during its training. The model then generates an output, which could be a continuation of the input text, an answer to a query, or other relevant textual content, by selecting words or tokens that have the highest probability of being contextually appropriate.

Furthermore, an LLM can be fine-tuned after its initial training for specific applications or tasks. This fine-tuning process involves additional training (e.g., with reinforcement from humans), usually on a smaller, task-specific dataset, which allows the model to adapt its responses to suit particular use cases more accurately. This adaptability makes LLMs highly versatile and applicable in various domains, including but not limited to, chatbot development, content creation, language translation, and sentiment analysis.

Some LLMs are multimodal in that they can receive prompts in formats other than text and can produce outputs in formats other than text. Thus, while LLMs are predominantly designed for understanding and generating textual data, multimodal LLMs extend this functionality to include multiple data modalities, such as visual and auditory inputs, in addition to text.

A multimodal LLM can employ an advanced neural network architecture, often a variant of the transformer model that is specifically adapted to process and fuse data from different sources. This architecture integrates specialized mechanisms, such as convolutional neural networks for visual data and recurrent neural networks for audio processing, allowing the model to effectively process each modality before synthesizing a unified output.

The training of a multimodal LLM involves multimodal datasets, enabling the model to learn not only language patterns but also the correlations and interactions between different types of data. This cross-modal training results in multimodal LLMs being adept at tasks that require an understanding of complex relationships across multiple data forms, a capability that text-only LLMs do not possess. This makes multimodal LLMs particularly suited for advanced applications that necessitate a holistic understanding of multimodal information, such as chatbots that can interpret and produce images and/or audio.

Some LLMs can employ a form of reasoning by transforming user-provided natural language input into a structured internal representation, which is then used to generate a response based on learned statistical associations and contextual dependencies. For complex queries requiring multi-step inference (e.g., mathematical problems, logical deductions, or temporal event analysis), the LLM can decompose the problem into intermediate steps by generating latent representations that reflect intermediate reasoning states. These states are influenced by the training data and are shaped during inference through techniques such as masked self-attention, positional encoding, and next-token prediction, which collectively allow the LLM to simulate deductive or abductive reasoning processes. In some embodiments, explicit chain-of-thought prompting is used to guide the LLM in generating a sequence of intermediate natural language steps, enhancing the LLM's ability to produce structured reasoning outputs. This capability enables the LLM to generate responses that are not merely retrieved facts but the result of multi-step inferential synthesis over the input data and the LLM's internal knowledge representation.

The natural language model 808 may also be used by the analysis engine 804 as part of its analysis of a change event. For instance, if a search of the threat model identifies a vulnerability in the source code, the analysis engine 804 may transmit queries to the natural language model 808 and receive modified code and/or analysis text relating to the vulnerability. The modified code may thus be used to address the vulnerability.

FIG. 8B depicts another configuration of the change analysis system 800, with similar components excepting the VCS 802B. As opposed to the VCS 802A, which stores and tracks changes made to source code, the VCS 802B stores and tracks changes made to configuration data, as discussed above.

The functionality of the change analysis system 800 and its components will be described in further detail below.

### C. Example Message Flow Diagrams

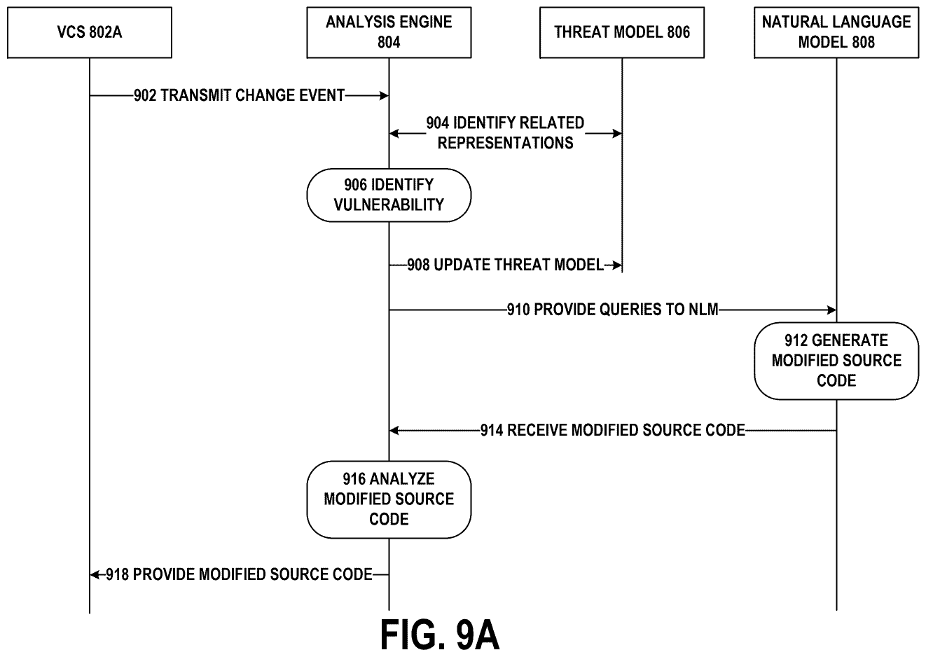

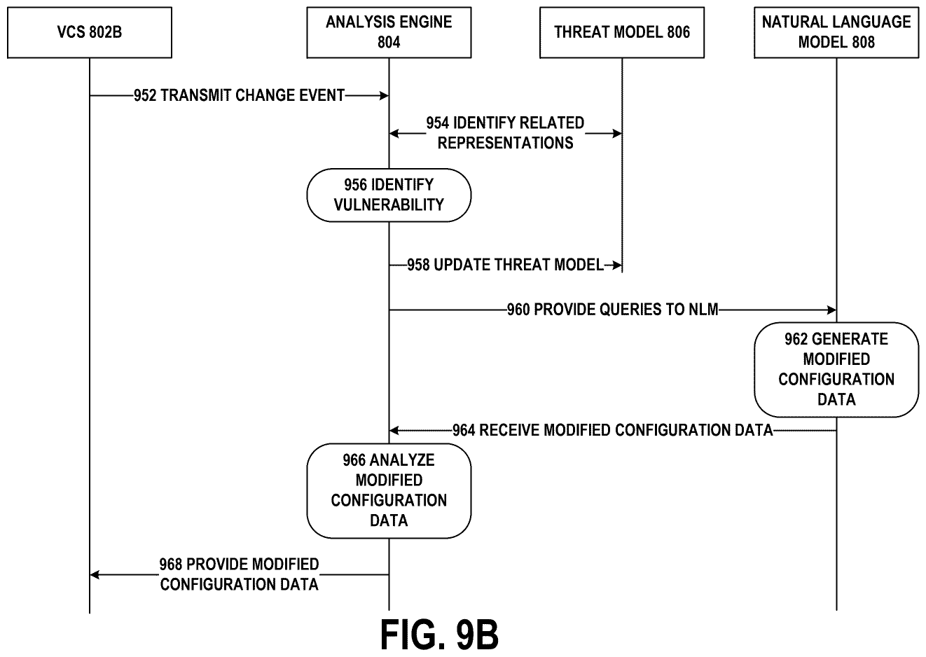

FIG. 9A depicts a message flow diagram for an example process that may be performed by the change analysis system 800 and/or the components thereof.

As shown at arrow 902, the VCS 802A may transmit a change event to the analysis engine 804. As noted above, change events may store changes made to source code, for instance added or removed lines of code as “deltas.” The change event may be transmitted to the analysis engine 804 using any type of communication protocol now known or later discovered. In some embodiments, the change event (or other indication of a change made to source code) may be transmitted by a user by way of a user interface.

The analysis engine 804 may then analyze the change event and, as shown at arrow 904, communicate with the threat model 806 to identify representations (e.g., components and/or relationships) within the threat model 806 that are related to the change event. For instance, if the change event includes changes to code relating to an API illustrated in the threat model, the analysis engine 804 may identify a representation of the API in the threat model 806, and determine whether the changes impact the API. If so, the related representations may be provided to the analysis engine 804.

In some embodiments, the analysis engine 804 may include a natural language model, a rules-based text parser, or other type of analysis system. Using the related representations and the change event, the analysis engine 804 may identify a vulnerability, as shown at block 906. Continuing the API example, the change may have inadvertently introduced a vulnerability within the API that a malicious actor could use to exfiltrate sensitive data from a system using the API. In some embodiments, the identification of related representations and/or the identification of a vulnerability may include receiving analysis text relating to the vulnerability to the source code from a natural language model (e.g., the natural language model 808, and/or a natural language model included within the analysis engine 804.

In some embodiments, especially when the analysis engine 804 identifies a vulnerability, the analysis engine 804 may determine that the threat model 808 does not include a representation of the vulnerability or a component involved in the vulnerability. For instance, a change event may include a new messaging protocol that had not been implemented before, and thus not recorded in the threat model 808. In such situations, the threat model may be updated to add a representation of this new vulnerability and/or protocol or other component, as shown at arrow 908. This may aid in future analysis of the source code. In some embodiments, this new representation within the threat model may prompt the analysis engine 804 to deny the change made to the source code. This denial may be transmitted to the VCS 802A, and the change event related to that change may be discarded.

Should a vulnerability be identified, the analysis engine 804 may obtain modified source code that mitigates this vulnerability. In some embodiments, this may involve providing the one or more queries to the natural language model 808, as shown at arrow 910. Such queries may include different types of information that may be useful in generating modified source code, including source code of the application, the source code associated with the change event, and/or a representation of code quality standards to be followed by the natural language model. The queries may also include the analysis text described above. The natural language model 808 may be any type of natural language model (such as the large language models described above). For instance, the natural language model 808 may be configured to generate source code given a source code basis and/or a textual (or other type) of description of a vulnerability.

The natural language model 808 may then generate modified source code that mitigates (or attempts to mitigate) the vulnerability, as shown at block 912. It may do so using the information provided in the queries and/or other information provided to the natural language model 808.

As shown at arrow 914, the analysis engine 804 may then receive the modified source code from the natural language model 808. The analysis engine 804 may then analyze the modified source code, as shown at block 916. This may involve determining whether the modified source code mitigates the vulnerability identified earlier in the process. This determination may involve further communications with the threat model 806, in a similar manner to arrow 904, block 906, and arrow 908 described above.

In some embodiments, this analysis may include providing the modified source code to the natural language model 808 and responsively receiving security test cases (e.g., code that explicitly tests the security of certain aspects of source code and/or an application as a whole) that relate to the vulnerability.

The analysis engine 804 may then execute these security test cases on the modified source code and, based on the results, update the threat model 806 accordingly. To execute these test cases, the analysis engine 804 may include a code execution environment. For instance, the security test cases may indicate that the vulnerability was addressed, or possibly identify further vulnerabilities. In the latter situation, the message flow may return to arrow 904 to address such vulnerabilities.

The analysis engine 804 may then provide the modified source code to the VCS 802A, as shown at arrow 918. This may involve approving the change event in the VCS 802A. The modified source code may then be provided to the application as an update. In some embodiments, the modified source code may be implemented into the source code of the application based on the aforementioned update.

FIG. 9B depicts a message flow diagram for another example process that may be performed by the change analysis system 800 and/or the components thereof. As shown, the VCS 802B contains change events relating to application configuration data, as described above, and the process may proceed accordingly. Generally, the message flow is similar to that of FIG. 9A, but concerns configuration data rather than source code. Indeed, each of the operations described above with regard to source code and/or modified source code are also possible with regard to configuration data and/or modified configuration data in some embodiments.

As shown at arrow 952, the VCS 802B may transmit a change event to the analysis engine 804. Changes to configuration data, as described above, can greatly impact the functioning of an application, and thus changes can also introduce security risks just as changes to source code may. For instance, changes to network settings (as in infrastructure configuration 606 in FIG. 6C) could inadvertently open a network to allow a malicious actor unauthorized access.

The analysis engine 804 may then analyze the change event and, as shown at arrow 954, communicate with the threat model 806 to identify representations (e.g., components and/or relationships) within the threat model 806 that are related to the change event. For instance, using the network settings example, the analysis engine 804 may identify a representation of that particular network communication or relationship in the threat model 806, and determine whether the changes impact that communication. If so, the related representations may be provided to the analysis engine 804.

As shown at block 956, a vulnerability related to the application may be identified in the change to the configuration data. In some embodiments, the identification of related representations and/or the identification of a vulnerability may include receiving analysis text relating to the vulnerability related to the application from a natural language model (e.g., the natural language model 808, and/or a natural language model included within the analysis engine 804.

In some embodiments, especially when the analysis engine 804 identifies a vulnerability, the analysis engine 804 may determine that the threat model 808 does not include a representation of the vulnerability or a component involved in the vulnerability. In such situations, the threat model may be updated to add a representation of this new vulnerability and/or component, as shown at arrow 958. This may aid in future analysis of configuration data. In some embodiments, this new representation within the threat model may prompt the analysis engine 804 to deny the change made to the configuration data. This denial may be transmitted to the VCS 802B, and the change event related to that change may be discarded.

Should a vulnerability to the application be identified within the configuration data, the analysis engine 804 may obtain modified configuration data that mitigates this vulnerability. In some embodiments, this may involve providing the one or more queries to the natural language model 808, as shown at arrow 960. Such queries may include different types of information that may be useful in generating modified configuration data, including other configuration data of the application and/or the configuration data associated with the change event. The queries may also include the analysis text described above.

The natural language model 808 may then generate modified configuration data that mitigates (or attempts to mitigate) the vulnerability to the application, as shown at block 962. It may do so using the information provided in the queries and/or other information provided to the natural language model 808.

As shown at arrow 964, the analysis engine 804 may then receive the modified configuration data from the natural language model 808. The analysis engine 804 may then analyze the modified configuration data, as shown at block 966. This may involve determining whether the modified configuration data mitigates the vulnerability related to the application identified earlier in the process. This determination may involve further communications with the threat model 806, in a similar manner to arrow 954, block 956, and arrow 958 described above.

The analysis engine 804 may then provide the modified configuration data to the VCS 802B, as shown at arrow 968. This may involve approving the change event in the VCS 802B. The modified configuration data may then be provided to the application as an update. In some embodiments, the modified configuration data may be implemented into the configuration data of the application based on the aforementioned update.

### X. Example Operations

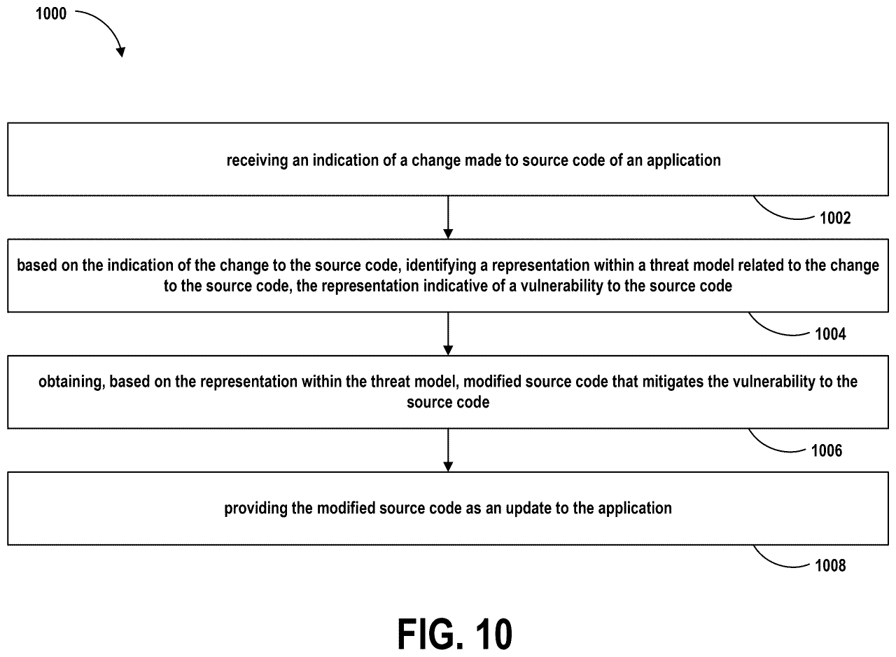

FIG. 10 is a flow chart illustrating an example embodiment. The process 1000 illustrated by FIG. 10 may be carried out by a computing device, such as computing device 100, and/or a cluster of computing devices, such as server cluster 200. However, the process can be carried out by other types of devices or device subsystems. For example, the process could be carried out by a computational instance of a remote network management platform or a portable computer, such as a laptop or a tablet device.

The embodiments of FIG. 10 may be simplified by the removal of any one or more of the features shown therein. Further, these embodiments may be combined with features, aspects, and/or implementations of any of the previous figures or otherwise described herein.

Block 1002 includes receiving an indication of a change made to source code of an application.

Block 1004 includes, based on the indication of the change to the source code, identifying a representation within a threat model related to the change to the source code, the representation indicative of a vulnerability to the source code. This presents a technical improvement as threat modeling aids in the identification of security risks that may arise when code is changed in an application. Through the use of threat modeling, the impact of such changes can be quickly determined and the risk addressed if necessary.

Block 1006 includes obtaining, based on the representation within the threat model, modified source code that mitigates the vulnerability to the source code. This presents a technical improvement as the modified source code may help address the security risks and improve the overall functioning of the application. Further, by promptly addressing such risks, instances of instances of data exfiltration, corruption, and loss, system disruptions and downtime, and the waste and misuse of computing resources associated with unaddressed security risks may be reduced.

Block 1008 includes providing the modified source code as an update to the application.

In some embodiments, the process 1000 may further include, based on the update to the application, implementing the modified source code into the source code of the application.

In some embodiments, the process 1000 may further include analyzing the indication of the change to the source code; based on the indication of the change to the source code, identifying a further vulnerability to the source code; determining that the threat model does not include a further representation of the further vulnerability; and adding the further representation of the further vulnerability to the threat model. In some embodiments, the process may further include, based on the further representation of the further vulnerability to the threat model, denying the change made to the source code.

In some embodiments, the process 1000 may further include providing, to a natural language model, the modified source code; and receiving, from the natural language model, security test cases related to the vulnerability to the source code. In some embodiments, the process 1000 may further include executing the security test cases on the modified source code; receiving results of the execution of the security test cases on the modified source code; and based on the results, updating the threat model.

In some embodiments, identifying the representation indicative of the vulnerability to the source code further includes receiving, from a natural language model, analysis text relating to the vulnerability to the source code.

In some embodiments, obtaining the modified source code includes providing, to a natural language model, one or more queries based on the representation indicative of the vulnerability to the source code; and receiving, from the natural language model, the modified source code. In some embodiments, the one or more queries include a further representation of code quality standards to be followed by the natural language model.

In some embodiments, the indication of the change made to the source code of the application is received from a version control system.

In some embodiments, the indication of the change made to the source code of the application is received from a user by way of a user interface.

In some embodiments, the process 1000 may further include receiving a further indication of a further change made to configuration data of a further application; based on the further indication of the further change to the configuration data, identifying a further representation within the threat model related to the further change to the configuration data, the further representation indicative of a further vulnerability related to the further application; obtaining, based on the further representation within the threat model, modified configuration data that mitigates the further vulnerability related to the further application; and providing the modified configuration data as a further update to the further application of platform.

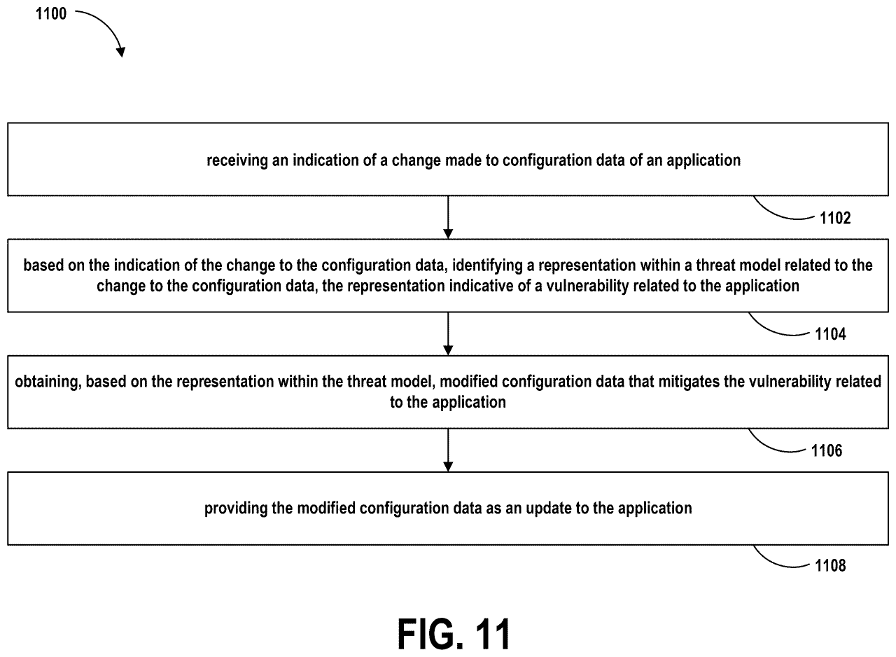

FIG. 11 is a flow chart illustrating an example embodiment. The process 1100 illustrated by FIG. 11 may be carried out by a computing device, such as computing device 100, and/or a cluster of computing devices, such as server cluster 200. However, the process can be carried out by other types of devices or device subsystems. For example, the process could be carried out by a computational instance of a remote network management platform or a portable computer, such as a laptop or a tablet device.

The embodiments of FIG. 11 may be simplified by the removal of any one or more of the features shown therein. Further, these embodiments may be combined with features, aspects, and/or implementations of any of the previous figures or otherwise described herein.

Block 1102 includes receiving an indication of a change made to configuration data of an application.

Block 1104 includes, based on the indication of the change to the configuration data, identifying a representation within a threat model related to the change to the configuration data, the representation indicative of a vulnerability related to the application. This presents a technical improvement as threat modeling aids in the identification of security risks that may arise when configuration data is changed in an application. Through the use of threat modeling, the impact of such changes can be quickly determined and the risk addressed if necessary.

Block 1106 includes obtaining, based on the representation within the threat model, modified configuration data that mitigates the vulnerability related to the application. This presents a technical improvement as the modified configuration data may help address the security risks and improve the overall functioning of the application. Further, by promptly addressing such risks, instances of instances of data exfiltration, corruption, and loss, system disruptions and downtime, and the waste and misuse of computing resources associated with unaddressed security risks may be reduced.

Block 1108 includes providing the modified configuration data as an update to the application.

In some embodiments, obtaining the modified configuration data includes providing, to a natural language model, one or more queries based on the representation indicative of the vulnerability related to the application; and receiving, from the natural language model, the modified configuration data.

In some embodiments, the process 1100 further includes, based on the update to the application, implementing the modified configuration data into the configuration data of the application.

In some embodiments, identifying the representation indicative of the vulnerability related to the application further includes receiving, from a natural language model, analysis text relating to the vulnerability related to the application.

In some embodiments, the process 1100 further includes analyzing the indication of the change to the configuration data; based on the indication of the change to the configuration data, identifying a further vulnerability related to the application; determining that the threat model does not include a further representation of the further vulnerability; and adding the further representation of the further vulnerability to the threat model. In some embodiments, the process further includes, based on the further representation of the further vulnerability to the threat model, denying the change made to the configuration data.

### XI. Closing

The present disclosure is not to be limited in terms of the particular embodiments described in this application, which are intended as illustrations of various aspects. Many modifications and variations can be made without departing from its scope, as will be apparent to those skilled in the art. Functionally equivalent methods and apparatuses within the scope of the disclosure, in addition to those described herein, will be apparent to those skilled in the art from the foregoing descriptions. Such modifications and variations are intended to fall within the scope of the appended claims.

The above detailed description describes various features and operations of the disclosed systems, devices, and methods with reference to the accompanying figures. The example embodiments described herein and in the figures are not meant to be limiting. Other embodiments can be utilized, and other changes can be made, without departing from the scope of the subject matter presented herein. It will be readily understood that the aspects of the present disclosure, as generally described herein, and illustrated in the figures, can be arranged, substituted, combined, separated, and designed in a wide variety of different configurations.

With respect to any or all of the message flow diagrams, scenarios, and flow charts in the figures and as discussed herein, each step, block, and/or communication can represent a processing of information and/or a transmission of information in accordance with example embodiments. Alternative embodiments are included within the scope of these example embodiments. In these alternative embodiments, for example, operations described as steps, blocks, transmissions, communications, requests, responses, and/or messages can be executed out of order from that shown or discussed, including substantially concurrently or in reverse order, depending on the functionality involved. Further, more or fewer blocks and/or operations can be used with any of the message flow diagrams, scenarios, and flow charts discussed herein, and these message flow diagrams, scenarios, and flow charts can be combined with one another, in part or in whole.

A step or block that represents a processing of information can correspond to circuitry that can be configured to perform the specific logical functions of a herein-described method or technique. Alternatively or additionally, a step or block that represents a processing of information can correspond to a module, a segment, or a portion of program code (including related data). The program code can include one or more instructions executable by a processor for implementing specific logical operations or actions in the method or technique. The program code and/or related data can be stored on any type of non-transitory computer readable medium such as a storage device including RAM, ROM, a disk drive, a solid-state drive, or another tangible storage medium.

Moreover, a step or block that represents one or more information transmissions can correspond to information transmissions between software and/or hardware modules in the same physical device. However, other information transmissions can be between software modules and/or hardware modules in different physical devices.

The particular arrangements shown in the figures should not be viewed as limiting. It should be understood that other embodiments could include more or less of each element shown in a given figure. Further, some of the illustrated elements can be combined or omitted. Yet further, an example embodiment can include elements that are not illustrated in the figures.

While various aspects and embodiments have been disclosed herein, other aspects and embodiments will be apparent to those skilled in the art. The various aspects and embodiments disclosed herein are for purpose of illustration and are not intended to be limiting, with the true scope being indicated by the following claims.

What is claimed is:

1. A method comprising:
receiving an indication of a change made to source code of an application;
based on the indication of the change to the source code, identifying a representation within a threat model related to the change to the source code, the representation indicative of a vulnerability to the source code;
obtaining, based on the representation within the threat model, modified source code that mitigates the vulnerability to the source code; and
providing the modified source code as an update to the application.

2. The method of claim 1, further comprising:
based on the update to the application, implementing the modified source code into the source code of the application.

3. The method of claim 1, further comprising:
analyzing the indication of the change to the source code;
based on the indication of the change to the source code, identifying a further vulnerability to the source code;
determining that the threat model does not include a further representation of the further vulnerability; and
adding the further representation of the further vulnerability to the threat model.

4. The method of claim 3, further comprising:
based on the further representation of the further vulnerability to the threat model, denying the change made to the source code.

5. The method of claim 1, further comprising:
providing, to a natural language model, the modified source code; and
receiving, from the natural language model, security test cases related to the vulnerability to the source code.

6. The method of claim 5, further comprising:
executing the security test cases on the modified source code;
receiving results of the execution of the security test cases on the modified source code; and
based on the results, updating the threat model.

7. The method of claim 1, wherein identifying the representation indicative of the vulnerability to the source code further comprises:
receiving, from a natural language model, analysis text relating to the vulnerability to the source code.

8. The method of claim 1, wherein obtaining the modified source code comprises:
providing, to a natural language model, one or more queries based on the representation indicative of the vulnerability to the source code; and
receiving, from the natural language model, the modified source code.

9. The method of claim 8, wherein the one or more queries comprise a further representation of code quality standards to be followed by the natural language model.

10. The method of claim 1, wherein the indication of the change made to the source code of the application is received from a version control system.

11. The method of claim 1, wherein the indication of the change made to the source code of the application is received from a user by way of a user interface.

12. The method of claim 1, further comprising:
receiving a further indication of a further change made to configuration data of a further application;
based on the further indication of the further change to the configuration data, identifying a further representation within the threat model related to the further change to the configuration data, the further representation indicative of a further vulnerability related to the further application;
obtaining, based on the further representation within the threat model, modified configuration data that mitigates the further vulnerability related to the further application; and
providing the modified configuration data as a further update to the further application of platform.

13. A method comprising:
receiving an indication of a change made to configuration data of an application;
based on the indication of the change to the configuration data, identifying a representation within a threat model related to the change to the configuration data, the representation indicative of a vulnerability related to the application;
obtaining, based on the representation within the threat model, modified configuration data that mitigates the vulnerability related to the application; and
providing the modified configuration data as an update to the application.

14. The method of claim 13, wherein obtaining the modified configuration data comprises:
providing, to a natural language model, one or more queries based on the representation indicative of the vulnerability related to the application; and
receiving, from the natural language model, the modified configuration data.

15. The method of claim 13, further comprising:
based on the update to the application, implementing the modified configuration data into the configuration data of the application.

16. The method of claim 13, wherein identifying the representation indicative of the vulnerability related to the application further comprises:
receiving, from a natural language model, analysis text relating to the vulnerability related to the application.

17. The method of claim 13, further comprising:
analyzing the indication of the change to the configuration data;
based on the indication of the change to the configuration data, identifying a further vulnerability related to the application;
determining that the threat model does not include a further representation of the further vulnerability; and
adding the further representation of the further vulnerability to the threat model.

18. The method of claim 17, further comprising:
based on the further representation of the further vulnerability to the threat model, denying the change made to the configuration data.

19. A non-transitory computer-readable medium, storing program instructions that, when executed by one or more processors of a computing system, cause the computing system to perform operations comprising:
receiving an indication of a change made to source code of an application;
based on the indication of the change to the source code, identifying a representation within a threat model related to the change to the source code, the representation indicative of a vulnerability to the source code;
obtaining, based on the representation within the threat model, modified source code that mitigates the vulnerability to the source code; and
providing the modified source code as an update to the application.

20. The non-transitory computer-readable medium of claim 19, wherein obtaining the modified source code comprises:
providing, to a natural language model, one or more queries based on the representation indicative of the vulnerability to the source code; and
receiving, from the natural language model, the modified source code.
